(19) United States
(12) Patent Application Publication
(10) Pub. No.: US 2023/0058675 A1
(43) Pub. Date: Feb. 23, 2023

(54) RADICALLY POLYMERIZABLE RESIN COMPOSITION AND CURED PRODUCT THEREOF

(71) Applicant: SHOWA DENKO K.K., Tokyo (JP)

(72) Inventors: Yoichiro SAKAGUCHI, Kumagaya-shi (JP); Kohei SAITO, Honjo-shi (JP)

(73) Assignee: SHOWA DENKO K.K., Tokyo (JP)

(21) Appl. No.: 17/788,455

(22) PCT Filed: Dec. 21, 2020
(86) PCT No.: PCT/JP2020/047644

§ 371 Date: Jun. 23, 2022

(30) Foreign Application Priority Data
Dec. 26, 2019 (JP) 2019-235911

(51) Int. Cl. C08F 283/01; C08K 13/02

(52) U.S. Cl. CPC C08F 283/01; C08K 13/02

(57) ABSTRACT

The invention provides a radically polymerizable resin composition capable of suppressing shrinkage while maintaining strength by adding an appropriate amount of an expansive additive to the radically polymerizable resin composition causing curing shrinkage by a decrease in the free volume of a liquid component during curing. The radically polymerizable resin composition comprises a radically polymerizable compound (A), an expansive additive (B), a radical polymerization initiator (C), and an aggregate (D). The aggregate (D) contains cement. The aggregate (D) is 330 to 800 parts by mass with respect to 100 parts by mass of the radically polymerizable compound (A).

### BACKGROUND

### Technical Field

The present invention relates to a radically polymerizable resin composition and a cured product thereof.

This application claims priority under Japanese Patent Application No. 2019-235911 filed on Dec. 26, 2019, the contents of which are incorporated herein by reference.

### Background Technology

When polymerization is carried out by using common liquid vinyl monomers, much large shrinkage occurs. The shrinkage causes strain problems when the vinyl monomers are used in industrial products. Therefore, it is important to produce a resin having a small shrinkage rate during polymerization.

Radically polymerizable resin compositions, such as unsaturated polyester resins and vinyl ester resins (epoxy acrylates), also generally shrink during curing. Since “styrene” and “methyl methacrylate”, which are monomers shown in Table 1 of Non-Patent Document 1, are often used as monomers, unsaturated polyester resins in general compositions undergo volume shrinkage of about 8 to 12%, and vinyl ester resins undergo volume shrinkage of about 8 to 10%.

The values are also much larger than the 3 to 6% volumetric shrinkage found in typical epoxy resins. This has prevented the use of unsaturated polyester resins or vinyl ester resins in this industrial application, as well as in other industries and applications.

As a method for solving this problem, Patent Document 1 discloses that by using polystyrene beads as a low-shrinkage material, the man-hours of manufacturing or the manufacturing time can be reduced, and a low-shrinkage unsaturated polyester resin composition having excellent small shrinkage, dimensional stability, and surface smoothness can be manufactured.

Further, Patent Document 2 discloses that by adding an A-B type block copolymer with an unsaturated polyester resin composition, a low-shrinkage unsaturated polyester resin composition capable of producing a molded product having low shrinkage at the time of curing and excellent heat resistance can be obtained.

Further, Patent Document 3 discloses that by mixing an A-B type block copolymer (vinyl acetate-styrene type) composed of A and B segments with fine particles of silicic acid, a low shrinkage unsaturated polyester resin composition having a large low shrinkage effect and high water resistance can be obtained when molding at room temperature or at medium temperature.

### PRIOR ART DOCUMENTS

### Patent Documents

[Patent Document 1] Japanese Patent Application Laid-Open No. Hei 11-315198
[Patent Document 2] Japanese Patent No. 2794802
[Patent Document 3] Japanese Patent Application Laid-Open No. Hei 05-222282

### Non-Patent Documents

[Non-Patent Document 1] Takeshi Endo, Whether volume shrinkage during polymerization is inevitable, Polymer, Vol. 27, February issue (1978), pages 108 to 111.

### SUMMARY

### Problems to be Solved by the Invention

In the conventional radically polymerizable resin composition, a thermoplastic resin such as polystyrene is used alone, or two or more kinds of block copolymers are used to produce a resin having a low shrinkage rate. They mostly function as “shrinkage preventive materials”.

In addition, these resin compositions are based on the idea of offsetting the thermal expansion of the thermoplastic resin due to the heat generated by curing and the curing shrinkage of the unsaturated polyester resin, and are often limited to applications such as sheet molding compounds (SMC) and bulk molding compounds (BMC) in which heat molding is performed in the middle temperature range or higher.

It is an object of the present invention to provide a radically polymerizable resin composition having a small shrinkage ratio by incorporating an expansive additive rather than the shrinkage preventing material, thereby expanding the resin composition as a whole at a constant ratio when the resin composition is cured, and then stabilizing the resin composition, without being limited to a molding method, a working temperature, an application, etc.

It is another object of the present invention to provide a cured product of a radically polymerizable composition without impairing fluidity.

### Means for Solving Problems

That is, the present invention is represented by the following [1] to [8].

[1] A radically polymerizable resin composition, comprising:

a radical polymerizable compound (A);

an expansive additive (B);

a radical polymerization initiator (C); and

an aggregate (D);
wherein the aggregate (D) comprises cement, and

an amount of the aggregate (D) is 330 to 800 parts by mass with respect to 100 parts by mass of the radically polymerizable compound (A).

[2] The radically polymerizable resin composition according to [1], wherein the radically polymerizable compound (A) comprises a vinyl ester resin and a radically polymerizable unsaturated monomer.

[3] The radically polymerizable resin composition according to [1] or [2], wherein the expansive additive (B) contains at least one kind selected from the group consisting of quicklime and calcium sulfoaluminate.

[4] The radically polymerizable resin composition according to any one of [1] to [3], wherein the radical polymerization initiator (C) is a hydroperoxide.

[5] The radically polymerizable resin composition according to any one of [1] to [4], further comprising a metal-containing compound (E) and a thiol compound (F).

[6] The radically polymerizable resin composition according to any one of [1] to [5], wherein an amount of the expansive additive (B) is 0.3 parts by mass to 30 parts by mass with respect to 100 parts by mass of the radically polymerizable compound (A).

[7] The radically polymerizable resin composition according to any one of [1] to [6], wherein an amount of the radical polymerization initiator (C) is 0.1 parts by mass to 10 parts by mass with respect to 100 parts by mass of the radically polymerizable compound (A).

[8] A cured product of the radically polymerizable resin composition according to any one of [1] to [7].

### Effect of the Invention

According to the present invention, the radical polymerizable resin composition having a small shrinkage rate can be provided by adding an appropriate amount of an expansive additive to the radical polymerizable resin composition, which causes curing shrinkage by decreasing free volume of liquid components when the resin composition is cured, thereby expanding the resin composition as a whole at a constant ratio when the resin composition is cured and then stabilizing the resin composition without being limited to a molding method, a working temperature, an application, etc.

Further, a cured product of the radically polymerizable composition without impairing fluidity can be provided.

### DETAILED DESCRIPTION OF DRAWINGS

FIG. 1 is a graph showing the results of Examples 1 to 4 and Comparative Example 1.

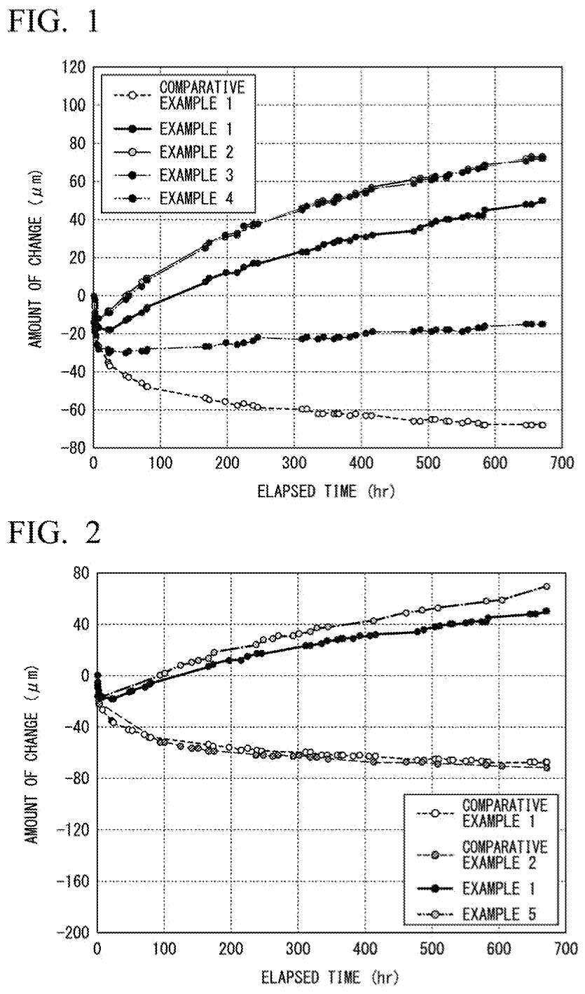

FIG. 2 is a graph showing the results of Example 5 and Comparative Example 2.

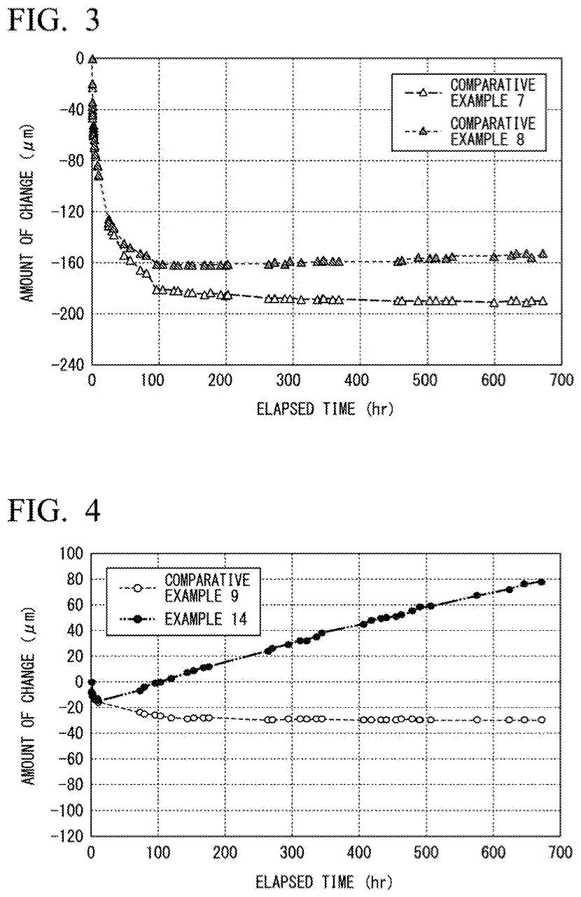

FIG. 3 is a graph showing the results of Comparative Example 7 and Comparative Example 8.

FIG. 4 is a graph showing the results of Example 9 and Comparative Example 14.

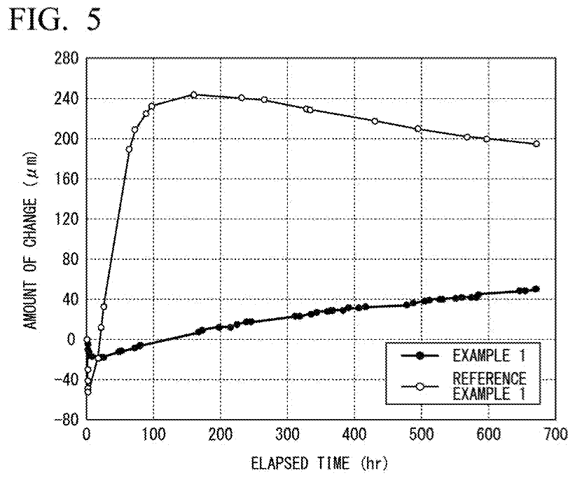

FIG. 5 is a graph showing the results of Example 1 and Reference Example 1.

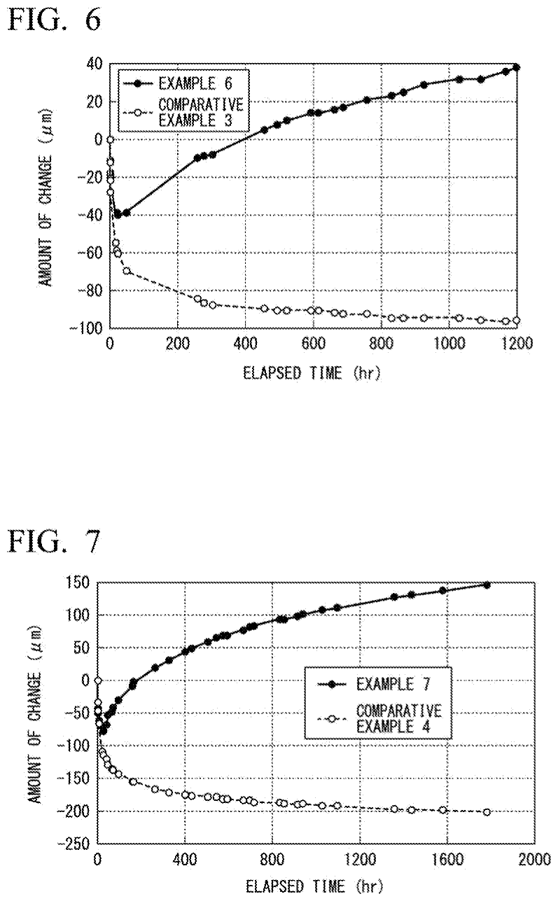

FIG. 6 is a graph showing the results of Example 6 and Comparative Example 3.

FIG. 7 is a graph showing the results of Example 7 and Comparative Example 4.

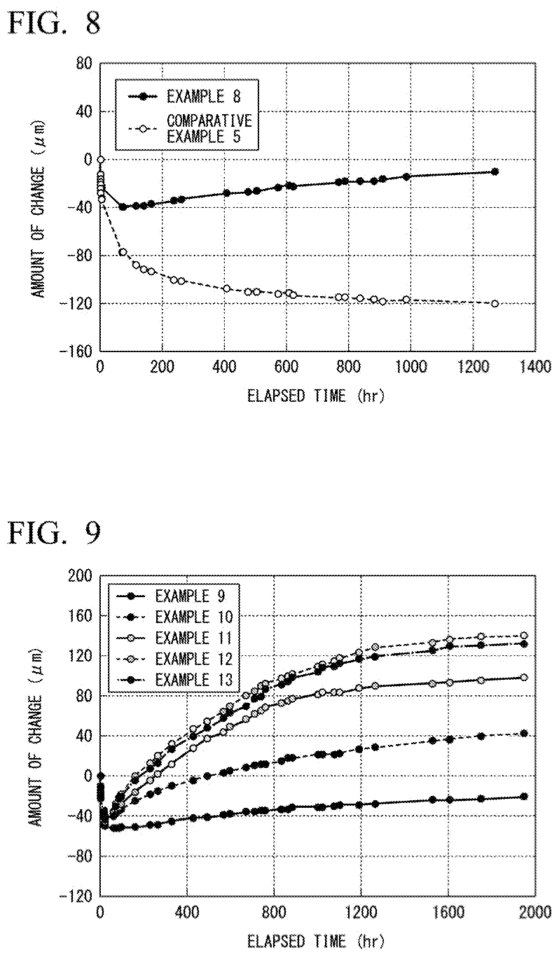

FIG. 8 is a graph showing the results of Example 8 and Comparative Example 5.

FIG. 9 is a graph showing the results of Examples 9 to 13.

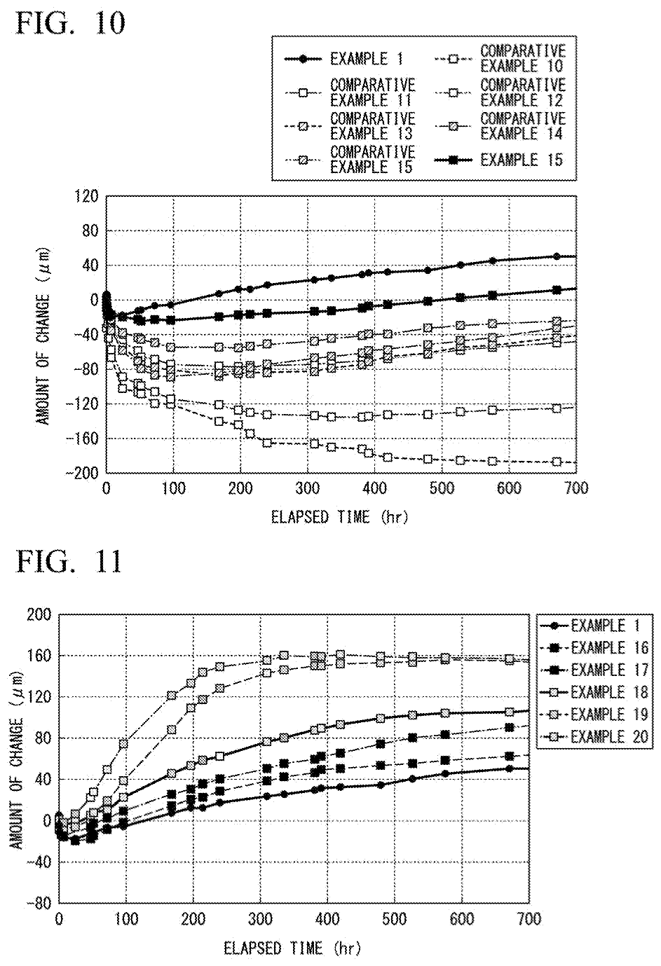

FIG. 10 is a graph showing the results of Examples 1, 15, and Comparative Examples 10 to 15.

FIG. 11 is a graph showing the results of Examples 1 and 16 to 20.

### DETAILED DESCRIPTION OF THE EMBODIMENTS

The present invention will now be described in detail.

(Radically Polymerizable Resin Composition)

The radically polymerizable resin composition comprises a radically polymerizable compound (A), an expansive additive (B), a radical polymerization initiator (C), and an aggregate (D), wherein the aggregate (D) contains cement.

<Radical Polymerizable Compound (A)>

The radically polymerizable resin composition uses a radically polymerizable compound (A) as a base material. In the present invention, the radical polymerizable compound (A) refers to a compound having an ethylenically unsaturated group in the molecule and undergoing a polymerization reaction by a radical.

Examples of the radically polymerizable compound (A) include a vinyl ester resin (epoxy (meth) acrylate resin), an unsaturated polyester resin, a polyester (meth) acrylate resin, a urethane (meth) acrylate resin, a (meth) acrylate resin, a radically polymerizable unsaturated monomer, and a mixture of the above-mentioned resins and a radically polymerizable unsaturated monomer. Among them, one or more kinds selected from a vinyl ester resin, an unsaturated polyester resin, and a mixture of these resins and a radically polymerizable unsaturated monomer are preferable. Among them, a vinyl ester resin is more preferable. In this specification, “(meth) acrylate” means “acrylate or methacrylate”.

[Vinyl Ester Resin]

The vinyl ester resin may be obtained by reacting an epoxy resin with an unsaturated monobasic acid.

Examples of the epoxy resin include bisphenol-type epoxy resin, biphenyl type epoxy resin, novolak type epoxy resin, trisphenol methane type epoxy resin, aralkyldiphenol type epoxy resin, naphthalene type epoxy resin, aliphatic type epoxy resin, and the like. These may be used alone or in combination.

Examples of the bisphenol-type epoxy resin include those obtained by reacting bisphenols with epichlorohydrin and/or methyl epichlorohydrin, and those obtained by reacting glycidyl ether of bisphenol A with a condensate of the bisphenols with epichlorohydrin and/or methyl epichlorohydrin. Examples of the bisphenols include bisphenol A, bisphenol F, bisphenol S, tetrabromobisphenol A, and the like.

Examples of the biphenyl type epoxy resin include those obtained by reacting biphenol with epichlorohydrin and/or methyl epichlorohydrin.

Examples of the novolak type epoxy resin include those obtained by reacting phenol novolak or cresol novolak with epichlorohydrin and/or methyl epichlorohydrin.

Examples of the trisphenolmethane-type epoxy resin include those obtained by reacting trisphenolmethane, triscresol methane with epichlorohydrin and/or methyl epichlorohydrin.

Examples of the aralkyldiphenol-type epoxy resin include those obtained by reacting aralkylphenol with epichlorohydrin and/or methyl epichlorohydrin.

Examples of the naphthalene type epoxy resin include those obtained by reacting dihydroxynaphthalene with epichlorohydrin and/or methyl epichlorohydrin.

Examples of the aliphatic type epoxy resin include an alicyclic type epoxy resin, an alicyclic diol diglycidyl ether type epoxy resin, an aliphatic diol diglycidyl ether type epoxy resin, a poly (oxyalkylene) glycol diglycidyl ether type epoxy resin, and the like.

Examples of the alicyclic type epoxy resin include an alicyclic diepoxy acetal, an alicyclic diepoxy adipate, and an alicyclic diepoxy carboxylate.

Specific examples of the alicyclic diol diglycidyl ether include diglycidyl ethers of alicyclic diols having 3 to 20 carbons (preferably 6 to 12 carbon atoms, more preferably 7 to 10 carbon atoms), such as cyclohexane dimethanol diglycidyl ether, dicyclopentenyl dialcohol diglycidyl ether, diglycidyl ether of hydrogenated bisphenol A, and dihydroxyterpene diglycidyl ether. A commercial product of cyclohexanedimethanol diglycidyl ether is “Denacol EX-216 L” of Nagase ChemteX Corporation.

Specific examples of aliphatic diol diglycidyl ethers include, for example, diglycidyl ethers of aliphatic diols having 2 to 20 carbons (preferably 4 to 12 carbon atoms, more preferably 4 to 8 carbon atoms, and particularly preferably 4 to 6 carbon atoms), such as 1,6-hexanediol diglycidyl ether, 1,4-butanediol diglycidyl ether, ethylene glycol diglycidyl ether, and propylene glycol diglycidyl ether. Among these, commercial products of 1,6-hexanediol diglycidyl ether include “Denacol EX-212 L” of Nagase ChemteX Co., Ltd., “SR-16 H” or “SR-16 HL” of Sakamoto Pharmaceutical Industry Co., Ltd., and “Epogose (registered trademark) HD” of Yokkaichi Synthetic Co., Ltd. In addition, a commercial product of 1, 4-butanediol diglycidyl ether is “Denacol EX-214 L” of Nagase ChemteX Co., Ltd.

Specific examples of the poly (oxyalkylene) glycol diglycidyl ether include, for example, diethylene glycol diglycidyl ether, polyethylene glycol diglycidyl ether, tripropylene glycol diglycidyl ether, polypropylene glycol diglycidyl ether, poly (tetramethylene) glycol diglycidyl ether, and the like.

Preferred examples of aliphatic epoxy resins include 1, 6-hexanediol diglycidyl ether, polyethylene glycol diglycidyl ether, poly (tetramethylene) glycol diglycidyl ether, and the like. Among them, those having a number-average molecular weight of 150 to 1000 are more preferable.

The epoxy resin may be a diglycidyl ester such as a dimer acid diglycidyl ester or a hexahydrophthalic acid diglycidyl ester. The epoxy resin includes an epoxy resin having an oxazolidone ring obtained by reacting the epoxy resin with a diisocyanate. Specific examples of epoxy resins having an oxazolidone ring include ARALDITE (registered trademark) AER 4152 made by Asahi Kasei Epoxy Co., Ltd.

Examples of the unsaturated monobasic acid include (meth) acrylic acid, crotonic acid, cinnamic acid, and the like. A product obtained by reacting a compound having one hydroxy group and one or more (meth) acryloyl groups with a polybasic acid anhydride may be used. In this specification, “(meth) acrylic acid” means one or both of “acrylic acid and methacrylic acid” and “(meth) acryloyl group” means one or both of “acryloyl group and methacryloyl group”.

The polybasic acid is used to increase the molecular weight of the epoxy resin, and can be used in a known manner. Examples of the polybasic acid include succinic acid, glutaric acid, adipic acid, sebacic acid, phthalic acid, fumaric acid, maleic acid, itaconic acid, tetrahydrophthalic acid, hexahydrophthalic acid, dimer acid, ethylene glycol 2 mol maleic anhydride adduct, polyethylene glycol 2 mol maleic anhydride adduct, propylene glycol 2 mol maleic anhydride adduct, polypropylene glycol 2 mol maleic anhydride adduct, dodecane diacid, tridecane diacid, octadecane diacid, 1, 16-(6-ethylhexadecane) dicarboxylic acid, 1, 12-(6-ethyldodecane) dicarboxylic acid, and carboxyl-terminated butadiene-acrylonitrile copolymer (trade name: Hycar CTBN).

[Unsaturated Polyester Resin]

The unsaturated polyester resin may be obtained by esterifying a dibasic acid component containing an unsaturated dibasic acid and, if necessary, a saturated dibasic acid with a polyhydric alcohol component.

Examples of the unsaturated dibasic acid include maleic acid, maleic anhydride, fumaric acid, itaconic acid, itaconic anhydride, and the like, which may be used alone or in combination of two or more kinds.

Examples of the saturated dibasic acid include, for example, aliphatic dibasic acids such as adipic acid, zuberic acid, azelaic acid, sebacic acid, and isosebic acid; aromatic dibasic acids such as phthalic acid, phthalic anhydride, halogenated phthalic anhydride, isophthalic acid, terephthalic acid, tetrachlorophthalic acid, tetrachlorophthalic anhydride, dimer acid, 2,6-naphthalenedicarboxylic acid, 2,7-naphthalenedicarboxylic acid, 2,3-naphthalenedicarboxylic acid, 2,3-naphthalenedicarboxylic acid anhydride, 4,4′-biphenyldicarboxylic acid, and dialkyl esters thereof; and halogenated saturated dibasic acids. These saturated dibasic acids may be used alone or in combination of two or more.

The polyhydric alcohol is not particularly limited, and examples of the polyhydric alcohol include dihydric alcohols such as ethylene glycol, propylene glycol, diethylene glycol, dipropylene glycol, 1,2-butanediol, 1,3-butanediol, 1,4-butanediol, 1,5-pentanediol, 1,6-hexanediol, neopentyl glycol, 2-methyl-1, 3-propanediol, 2-methyl-1, 4-butanediol, 2, 2-dimethyl-1, 3-propanediol, 2, 2, 4-trimethyl-1, 3-pentanediol, 2-ethyl-2 butyl-1, 3-propanediol, 3-methyl-1, 5-pentanediol, diethylene glycol, triethylene glycol, polyethylene glycol, dipropylene glycol, polypropylene glycol, 1, 2-cyclohexane glycol, 1, 3-cyclohexane glycol, 1, 4-cyclohexane glycol, 1,4-cyclohexanedimethanol, paraxylene glycol, bicyclohexyl-4, 4′-diol, 2,6-decalin glycol, and 2,7-decalin glycol;

dihydric alcohols such as adducts of dihydric phenols represented by hydrogenated bisphenol A, cyclohexanedimethanol, bisphenol A, bisphenol F, bisphenol S, tetrabromobisphenol A, and the like with alkylene oxides represented by propylene oxide or ethylene oxide; and

trivalent or higher alcohols such as 1,2,3,4-tetrahydroxybutane, glycerin, trimethylolpropane, and pentaerythritol.

The unsaturated polyester may be modified with a dicyclopentadiene-based compound to the extent that the effect of the present invention is not impaired. Examples of the method of modifying the unsaturated polyester by the dicyclopentadiene-based compound include a known method such as a method of obtaining an addition product (cidecanol monomaleate) of a dicyclopentadiene and a maleic acid, and introducing a dicyclopentadiene skeleton by using, as a single basic acid, the resulting addition product.

Oxidative polymerization (air curing) groups such as allyl groups or benzyl groups can be introduced into the vinyl ester resin or unsaturated polyester resin used in the present invention. The introduction method is not particularly limited. Examples of the introduction method include a method of addition of a polymer containing an oxidation polymerization group; a method of condensation of a compound having a hydroxyl group and an allyl ether group; and a method of addition of a reaction product which is obtained by reacting allyl glycidyl ether or 2, 6-diglycidyl phenyl allyl ether with a compound having a hydroxyl group and an allyl ether group and with an acid anhydride.

The oxidative polymerization (air curing) in the present invention refers to crosslinking accompanied by formation and decomposition of a peroxide by oxidation of a methylene bond between an ether bond and a double bond, which is found in, for example, an allyl ether group.

[Polyester (Meth) Acrylate Resin, Urethane (Meth) Acrylate Resin, and (Meth) Acrylate Resin]

Examples of the polyester (meth) acrylate resin in the present invention include a polyester obtained by reacting a polycarboxylic acid with a polyhydric alcohol, specifically a resin obtained by reacting (meth) acrylic acid with hydroxyl groups at both ends of polyethylene terephthalate or the like.

Examples of the urethane (meth) acrylate resin include a resin obtained by reacting (meth) acrylic acid with hydroxyl groups or isocyanate groups at both ends of a polyurethane obtained by reacting an isocyanate with a polyhydric alcohol.

Examples of the (meth) acrylate resin include a poly (meth) acrylic resin having one or more substituents selected from a hydroxyl group, an isocyanate group, a carboxy group, and an epoxy group; and a resin obtained by reacting a (meth) acrylic ester having a hydroxyl group with the substituents of a polymer which is obtained by polymerization of the (meth) acrylate and the monomer having one or more substituents selected from a hydroxyl group, an isocyanate group, a carboxy group, and an epoxy group.

[Radically Polymerizable Unsaturated Monomer]

In the present invention, a radically polymerizable unsaturated monomer can be used as the radically polymerizable compound (A).

The radically polymerizable unsaturated monomer may be used alone, but is preferably used as a mixture of the radically polymerizable unsaturated monomer and at least one of the vinyl ester resin and the unsaturated polyester resin.

The radically polymerizable unsaturated monomer is not particularly limited, but preferably has a vinyl group or a (meth) acryloyl group.

Specific examples of the monomer having the vinyl group include styrene, p-chlorostyrene, vinyltoluene, α-methyl styrene, dichlorostyrene, divinylbenzene, tert-butylstyrene, vinyl acetate, diallyl phthalate, triallyl isocyanurate, and the like.

Specific examples of monomers having (meth) acryloyl groups include (meth) acrylate esters and the like. Examples of the (meth) acrylate esters include methyl (meth) acrylate, ethyl (meth) acrylate, n-butyl (meth) acrylate, iso-butyl (meth) acrylate, tert-butyl (meth) acrylate, 2-ethylhexyl (meth) acrylate, lauryl (meth) acrylate, cyclohexyl (meth) acrylate, benzyl (meth) acrylate, stearyl (meth) acrylate, tridecyl (meth) acrylate, cyclohexyl (meth) acrylate, dicyclopentanyl (meth) acrylate, dicyclopentenyl (meth) acrylate, dicyclopentenyloxyethyl (meth) acrylate, phenoxyethyl methacrylate, 2-hydroxyethyl methacrylate, ethylene glycol monomethyl ether (meth) acrylate, ethylene glycol monoethyl ether (meth) acrylate, ethylene glycol monobutyl ether (meth) acrylate, ethylene glycol monohexyl ether (meth) acrylate, ethylene glycol mono-2-ethylhexyl ether (meth) acrylate, diethylene glycol monomethyl ether (meth) acrylate, diethylene glycol monoethyl ether (meth) acrylate, diethylene glycol monobutyl ether (meth) acrylate, diethylene glycol monohexyl ether (meth) acrylate, diethylene glycol mono-2-ethylhexyl ether (meth) acrylate, neopentyl glycol di (meth) acrylate, PTMG dimethacrylate, 1,3-butylene glycol di (meth) acrylate, 1,6-hexanediol di (meth) acrylate, neopentyl glycol di (meth) acrylate, 2-hydroxy-1, 3-dimethacryloxypropane, 2,2-bis [4-(methacryloyl ethoxy) phenyl] propane, 2,2-bis [4-(methacryloxy-diethoxy) phenyl] propane, 2,2-bis [4-(methacryloxy-polyethoxy) phenyl] propane, tetraethylene glycol diacrylate, bisphenol AEO-modified (n=2) diacrylate, isocyanuric acid EO-modified (n=3) diacrylate, pentaerythritol diacrylate monostearate, dicyclopentenyl acrylate, dicyclopentenyl oxyethyl acrylate, tricyclodecanyl (meth) acrylate, tris (2-hydroxyethyl) isocyanuryl acrylate, and the like.

Further, examples of the polyfunctional (meth) acrylate ester include alkanediol di (meth) acrylates such as ethylene glycol di (meth) acrylate, 1,2-propylene glycol di (meth) acrylate, 1,3-butylene glycol di (meth) acrylate, 1,4-butylene glycol di (meth) acrylate, neopentyl glycol di (meth) acrylate, 1,6-hexanediol di (meth) acrylate, and the like; and polyoxyalkylene glycol di (meth) acrylates such as diethylene glycol di (meth) acrylate, dipropylene glycol di (meth) acrylate, triethylene glycol (meth) acrylate, tetraethyl ene glycol di (meth) acrylate, polyethylene glycol (meth) acrylate; trimethylolpropane di (meth) acrylate, glycerol di (meth) acrylate, pentaerythritol di (meth) acrylate, trimethylolpropane tri (meth) acrylate, glycerol tri (meth) acrylate, pentaerythritol tri (meth) acrylate, pentaerythritol tetra (meth) acrylate, dipentaerythritol hexa (meth) acrylate, and the like.

Further, the following compounds may be used as the radically polymerizable unsaturated monomer. Examples thereof include divinylbenzene, diallyl phthalate, triallyl phthalate, triallyl cyanurate, triallyl isocyanurate, allyl (meth) acrylate, diallyl fumarate, allyl methacrylate, vinyl benzyl butyl ether, vinyl benzyl hexyl ether, vinyl benzyl octyl ether, vinyl benzyl (2-ethylhexyl) ether, vinyl benzyl (β-methoxymethyl) ether, vinyl benzyl (n-butoxypropyl) ether, vinyl benzyl cyclohexyl ether, vinyl benzyl (β-phenoxyethyl) ether, vinyl benzyl dicyclopentenyl ether, vinyl benzyl dicyclopentenyl oxyethyl ether, vinyl benzyl dicyclopentenyl methyl ether, and divinylbenzyl ether.

In addition to the above, dicyclopentenyl (meth) acrylate, dicyclopentenyloxyethyl (meth) acrylate, and the like can be used.

These may be used alone or in combination of two or more species.

The radically polymerizable unsaturated monomer can be used to reduce the viscosity of the radically polymerizable resin composition of the present invention and to improve the hardness, strength, chemical resistance, water resistance, etc.; however, if the content of the radically polymerizable unsaturated monomer is too high, it may lead to deterioration of the cured product and environmental pollution. Therefore, the content of the radically polymerizable unsaturated monomer is preferably 90% by mass or less in the radically polymerizable compound (A).

In the radical polymerizable compound (A), the catalyst or the polymerization inhibitor which are used in the steps of synthesizing a vinyl ester resin, an unsaturated polyester resin, a polyester (meth) acrylate resin, a urethane (meth) acrylate resin, and a (meth) acrylate resin may remain in the reaction system. Examples of the catalyst include a compound containing tertiary nitrogen such as triethylamine, pyridine derivative, imidazole derivative, and the like; an amine salt such as tetramethylammonium chloride, triethylamine, and the like; and a phosphorus compound such as trimethylphosphine, triphenylphosphine, and the like.

Examples of the polymerization inhibitor include hydroquinone, methyl hydroquinone, phenothiazine, and the like.

When the catalyst or the polymerization inhibitor remains in the radically polymerizable compound (A), the amount thereof is preferably 0.001 to 2 parts by mass with respect to 100 parts by mass of a total amount of the vinyl ester resin and the unsaturated polyester resin.

The content of the radically polymerizable compound (A) in the radically polymerizable resin composition of the present invention is preferably 5 to 99.9% by mass, more preferably 10 to 80% by mass, still more preferably 15 to 60% by mass, and most preferably 18 to 40% by mass. When the content of the radical polymerizable compound (A) in the radical polymerizable resin composition is within the above range, the hardness of the cured product is further improved.

<Expansive Additive (B)>

The expansive additive (B) used in the present invention may be any expansive additive as long as the expansive additive (B) is generally used as an expansive additive for concrete and satisfies the Japanese Industrial Standard JIS A 6202 “Expansive Additive for Concrete”. Specially, an expansive additive from which calcium hydroxide or ettringite may be formed by a hydration reaction may be used. For example, the expansive additive (B) containing at least one kind selected from the group consisting of quicklime and calcium sulfoaluminate is preferable. More preferable expansive additives include (1) an expansive additive containing quicklime as an active component (quicklime-based expansive additive), (2) an expansive additive containing calcium sulfoaluminate as an active component (ettringite-based expansive additive), and (3) a quicklime/ettringite composite expansive additive.

Specific examples of quicklime-based expansive additives include Taiheiyo Hyper Expan-K, Taiheiyo Hyper Expan-M, Taiheiyo Expan-K, Taiheiyo Expan-M, and Taiheiyo N-EX made by Taiheiyo Materials Corporation.

Specific examples of the ettringite-based expansive additive include Denca CSA #10 and Denca CSA #20 made by Denca.

Specific examples of the quicklime/ettringite composite expansive additive include Denka Power CSA Type S, Denka Power CSA Type R, and Denka Power CSA Type T made by Denka Company Limited.

The amount of the expansive additive (B) of the present invention is preferably 0.3 to 30 parts by mass, more preferably 0.5 to 25 parts by mass, still more preferably 0.7 to 20 parts by mass, and most preferably 1 to 16 parts by mass with respect to 100 parts by mass of the radically polymerizable compound (A). When the amount of the expansive additive (B) is 30 parts by mass or less, the expansion rate does not exceed the elongation amount of the resin when the radically polymerizable resin composition is cured. On the other hand, when the amount is 0.3 parts by mass or more, it is impossible that the expansion performance with respect to the radical polymerizable compound (A) does not appear. These expansive additives (B) may be used alone or may be used by mixing two or more kinds.

<Radical Polymerization Initiator (C)>

The radically polymerizable resin composition contains a radical polymerization initiator (C) as a curing agent. Examples of the radical polymerization initiator (C) include a thermal radical polymerization initiator (C1) and a photoradical polymerization initiator (C2). Among them, a thermal radical polymerization initiator (C1) is preferable.

Examples of the thermal radical polymerization initiator (C1) include an organic peroxide-based radical polymerization initiator such as a diacylperoxide-based radical polymerization initiator such as benzoyl peroxide; a peroxyester system such as tert-butyl peroxybenzoate; a hydroperoxide system-based radical polymerization initiator (RCOOH, hydroperoxide) such as cumene hydroperoxide (CHP), diisopropylbenzene hydroperoxide, tert-butyl hydroperoxide, and paramentane hydroperoxide; a dialkyl peroxide-based radical polymerization initiator such as dicumyl peroxide; a ketone peroxide-based radical polymerization initiator such as methylethyl ketone peroxide and acetylacetone peroxide; a peroxyketal system; an alkyl perester-based radical polymerization initiator; a percarbonate-based radical polymerization initiator, and the like. Among them, the hydroperoxide-based radical polymerization initiator (RCOOH) (also referred to simply as hydroperoxides) are preferable; and cumene hydroperoxides (CHP) such as PERCUMYL (registered trademark) H-80 produced by Nichiyu Corporation and diisopropylbenzene hydroperoxides such as PERCUMYL (registered trademark) P produced by Nichiyu Corporation, and the like are more preferable.

Examples of the photoradical polymerization initiator (C2) include benzoin ethers such as benzoin alkyl ethers; benzophenones such as benzophenone, benzyl, methyl orthobenzoyl benzoate; acetophenone such as benzyl dimethyl ketal, 2,2-diethoxyacetophenone, 2-hydroxy-2 methylpropiophenone, 4-isopropyl-2 hydroxy-2 methylpropiophenone, and 1,1-dichloroacetophenone; and thioxanthone such as 2-chlorothioxanthone, 2-methylthioxanthone, and 2-isopropylthioxanthone.

Examples of the photoradical polymerization initiator (C2) having photosensitivity in the range from ultraviolet light to visible light include known initiators such as acetophenone, benzyl ketal, and (bis) acylphosphine oxide. Specific examples of the photoradical polymerization initiator (C2) include Irgacure-1700 (Ciba Specialty Chemicals Co., Ltd.) which is a product name and is obtained by mixing 2-hydroxy methyl-1-phenylpropane-1-one (product name: Darocur 1173, manufactured by Ciba Specialty Chemicals Co., Ltd.) and bis (2, 6-dimethoxybenzoyl)-2, 4, 4-trimethylpentylphosphine oxide (Ciba Specialty Chemicals Co., Ltd.) at a ratio of 75%/25%; Irgacure 1800, a 75%/25% mixture of 1-hydroxycyclohexyl phenyl ketone (product name: Irgacure 184, manufactured by Ciba Specialty Chemicals Co., Ltd.) and bis (2, 6-dimethoxybenzoyl)-2, 4, 4-trimethylpentylphosphine oxide (manufactured by Ciba Specialty Chemicals Co., Ltd.), Irgacure 1850, a 50%/50% mixture thereof; bis (2,4,6-trimethylbenzoyl) phenylphosphine oxide (product name: Irgacure 819, manufactured by Ciba Specialty Chemicals Co., Ltd.); 2,4,6-trimethylbenzoyldiphenylphosphine oxide (product name: Lucirin TPO, manufactured by BASF Co., Ltd.); Darocur 4265, which is a trade name and is a 50%/50% mixture of 2-hydroxy-2-methyl-1-phenylpropane-1-one (product name: Darocur 1173, manufactured by Ciba Specialty Chemicals Co., Ltd.) and 2, 4, 6-trimethylbenzoyldiphenylphosphine oxide (product name: Lucirin TPO, manufactured by BASF Co., Ltd.).

Examples of the photoradical polymerization initiator (C2) having photosensitivity in the visible light region include camphorquinone, benzyl trimethyl benzoyl diphenylphosphinoxide, methylthioxanthone, dicyclopentadiethyltitanium-di (pentafluorophenyl), and the like.

These radical polymerization initiators (C) may be used alone or used by mixing two or more of them. For the purpose of assisting main reaction of the thermosetting and photocuring reactions, the other reaction may be incorporated. Further, the thermal radical polymerization initiator (C1) and the photoradical polymerization initiator (C2) may be used together as necessary.

Depending on the molding conditions, the radical polymerization initiators (C) may be used in a composite form such as a composite of an organic peroxide and dye system, a composite of a diphenyliodine salt and dye system, a composite of an imidazole and keto compound, a composite of a hexaallylbiimidazole compound and hydrogen donating compound, a composite of a mercaptobenzothiazole and thiopyrium salt, a composite of a metal arene and cyanine dye, a composite of a hexaallylbiimidazole and radical generator, and the like.

When the radical polymerizable resin composition of the present invention contains a radical polymerization initiator (C), the amount thereof is preferably 0.1 to 10 parts by mass, more preferably 0.2 to 8.0 parts by mass, still more preferably 0.3 to 6.0 parts by mass, and most preferably 0.3 to 5.0 parts by mass with respect to 100 parts by mass of the radical polymerizable compound (A).

<Aggregate (D)>

The radically polymerizable resin composition contains an aggregate (D) which includes cement. Another component of aggregate (D) than cement is not particularly limited, and mortar or concrete can be used. Examples of the components of aggregates other than cement include, but are not limited to, calcium carbonate, crushed stone, sandstone, cryolite, marble, quartz, limestone, silica sand, silica stone, river sand, and the like. From the viewpoint of weight reduction, lightweight aggregates such as sintered shale, silicate-based balloon, and non-silicate-based balloon perlite can also be used. Among these, silica sand is preferable, and No. 7 silica sand and No. 8 silica sand are more preferable.

As the cement, Portland cement, other mixed cement, superspeed hardening cement, or the like can be used without any particular limitation. As the Portland cement, various Portland cements such as low heat Portland cement, moderate heat Portland cement, ordinary Portland cement, early-strength Portland cement, super early-strength Portland cement, sulfate resistance Portland cement, and the like can be used. Examples of the mixed cements include blast furnace cement, fly ash cement, silica cement, and the like. Among these, inexpensive Portland cement is preferable, and early-strength Portland cement and super early-strength Portland cement are more preferable. The cement may be used by singly using one of the above illustrated cements or by using a mixture of the above illustrated cements at any combination and at any mixing ratio.

Calcium carbonate functions as a constitutional pigment which is transparent in the coating film and which does not hide the surface to be coated (base material surface), and has functions such as filling recessed parts and reducing coating cost. Examples of the calcium carbonate on the market include TM-2 (manufactured by Yuko Mining Co., Ltd.).

Since the calcium carbonate has a specific particle size distribution, is excellent in dispersibility, and is porous, the specific gravity of the aggregate itself can be reduced to make it difficult to drip, and the film-forming property can be improved.

Examples of silicic acid balloons include shirasu balloons, perlite, glass (silica) balloons, fly ash balloons, and the like. Examples of non-silicic acid balloons include alumina balloons, zirconia balloons, carbon balloons, and the like. Specific examples of perlite include perlite FL-0 (product name: manufactured by Fuyo Perlite Co., Ltd.), HARDLITE B-03, HARDLITE B-04, and HARDLITE B-05 (product name, manufactured by Showa Chemical Co., Ltd.).

The amount of the aggregate (D) in the composition of the present invention is not particularly limited, but is 330 to 800 parts by mass, preferably 350 to 800 parts by mass, and more preferably 370 to 450 parts by mass with respect to 100 parts by mass of the radically polymerizable compound (A). In particular, when the amount of the aggregate is 330 parts by mass or more, practical fluidity can be secured. When the amount of the aggregate is 800 parts by mass or less, the adhesion amount of the trowel is reduced, and the deterioration of workability can be prevented.

The amount of cement in the aggregate (D) is not particularly limited, but is preferably 1 to 80 parts by mass, more preferably 5 to 50 parts by mass, and still more preferably 5 to 30 parts by mass in 100 parts by mass of the aggregate (D). In particular, when the amount of the cement is 1 part by mass or more, the particle size distribution of the aggregate can be optimized to secure practical fluidity. When the amount of the cement is 80 parts by mass or less, stickiness due to deterioration of fluidity can be prevented.

<Metal-Containing Compound (E)>

In the radically polymerizable resin composition, one or more kinds of metal-containing compounds (E) selected from a metal soap (E1) and a metal complex (E2) having a β-diketone skeleton can be used as a curing accelerator. The metal soap (E1) in the present invention refers to a salt of a long-chain fatty acid or an organic acid other than a long-chain fatty acid and a metal element other than potassium and sodium. The metal complex (E2) having a β-diketone skeleton in the present invention refers to a complex in which a compound having a structure which has one carbon atom between two carbonyl groups is coordinated to a metal element.

The amount of the metal-containing compound (E) in the radically polymerizable resin composition in terms of the metal component is preferably 0.0001 to 5 parts by mass, more preferably 0.001 to 4 parts by mass, and still more preferably 0.005 to 3 parts by mass with respect to 100 parts by mass of the radically polymerizable compound (A). When the amount of the metal-containing compound (E) in terms of the metal component is within the above range, curing proceeds rapidly even in water and a wet atmosphere.

[Metal Soap (E1)]

The long-chain fatty acid in the metal soap (E1) is not particularly limited, but for example, a fatty acid having 6 to 30 carbon atoms is preferable. Specific examples of the long-chain fatty acid preferably include linear fatty acids or cyclic saturated fatty acids such as heptanoic acid, octanoic acid such as 2-ethylhexanoic acid, nonanoic acid, decanoic acid, neodecanoic acid, undecanoic acid, dodecanoic acid, tetradecanoic acid, hexadecanoic acid, octadecanoic acid, eicosanoic acid, docosanoic acid, tetracosanoic acid, hexacosanoic acid, octacosanoic acid, triacontanoic acid, and naphthenic acid; and unsaturated fatty acids such as oleic acid, linoleic acid, and linolenic acid.

Rosinic acid, flaxseed oil fatty acid, soybean oil fatty acid, tall oil acid, and the like can also be used.

The organic acid other than the long-chain fatty acid in the metal soap (E1) is not particularly limited, but a weak acid compound having a carboxy group, a hydroxy group, and an enol group and soluble in an organic solvent is preferable.

Examples of the compound having a carboxy group include a carboxylic acid such as formic acid, acetic acid, oxalic acid, and the like; a hydroxy acid such as citric acid, bile acid, sugar acid, 12-hydroxystearic acid, hydroxycinnamic acid, folic acid, and the like; amino acids such as alanine, arginine, and the like; and an aromatic acid such as benzoic acid, phthalic acid, and the like.

Examples of the compound having the hydroxy group and the enol group include ascorbic acid, a acid, imide acid, erythorbic acid, croconic acid, kojic acid, squalic acid, sulfinic acid, taichoic acid, dehydroacetic acid, delta acid, uric acid, hydroxamic acid, humic acid, fulvic acid, phosphonic acid, and the like.

Among these, long-chain fatty acids are preferable; chain or cyclic saturated fatty acids having 6 to 16 carbon atoms or unsaturated fatty acids having 6 to 16 carbon atoms are more preferable; octanoic acid, 2-ethylhexanoic acid, and naphthenic acid are still more preferable; and 2-ethylhexanoic acid and naphthenic acid are most preferable.

The metal elements constituting the metal soap (E1) include Groups 1 to 2 metal elements such as lithium, magnesium, calcium, and barium (however, potassium and sodium are excluded), Groups 3 to 12 metal elements such as titanium, zirconium, vanadium, manganese, iron, ruthenium, cobalt, rhodium, nickel, palladium, platinum, copper, silver, gold, and zinc; Groups 13 to 14 metal elements such as aluminum, indium, tin, and lead; rare earth metal elements such as neodymium and cerium; bismuth; and the like.

In the present invention, Groups 2 to 12 metal elements are preferred; zirconium, barium, vanadium, manganese, iron, cobalt, copper, titanium, bismuth, calcium, lead, tin, and zinc are more preferred; zirconium, manganese, iron, cobalt, copper, titanium, bismuth, calcium, lead, tin, and zinc are still more preferred; and zirconium, manganese, cobalt, bismuth, and calcium are most preferred.

Specific examples of the metal soap (E1) preferably include zirconium octylate, manganese octylate, cobalt octylate, bismuth octylate, calcium octylate, zinc octylate, vanadium octylate, lead octylate, tin octylate, cobalt naphthenate, copper naphthenate, barium naphthenate, bismuth naphthenate, calcium naphthenate, lead naphthenate, and tin naphthenate, and more preferably zirconium octylate octylate, manganese octylate, cobalt octylate, bismuth octylate, calcium octylate, lead octylate, tin octylate, bismuth naphthenate, calcium naphthenate, lead naphthenate, and tin naphthenate. Among them, manganese octylate and cobalt octylate are more preferable. Specific examples of the cobalt octylate include hexoate cobalt (cobalt amount in the entire product: 8% by mass, molecular weight: 345.34) produced by Toei Corporation. Specific examples of manganese octylate include hexoate manganese (manganese amount in the total amount of the product: 8% by mass, molecular weight: 341.35) produced by Toei Chemical Industries, Ltd.

[Metal Complex with β-Diketone Skeleton (E2)]

A metal complex (E2) having a β-diketone skeleton, hereinafter, is also referred to as a “metal complex (E2)”. Examples of the metal complex (E2) include a complex formed from acetylacetone, ethyl acetoacetate, benzoylacetone, or the like and a metal. Further, these metal complexes (E2) exhibit the same function as the metal soap (E1).

As the metal element constituting the metal complex (E2), a metal element similar to the metal soap (E1) can be used.

Specific examples of the metal complex (E2) preferably include zirconium acetylacetonate, vanadium acetylacetonate, cobalt acetylacetonate, titanium acetylacetonate, titanium dibutoxybis (acetylacetonate), iron acetylacetonate, and acetoacetate ethyl ester cobalt. Further, zirconium acetylacetonate, titanium acetylacetonate, and titanium dibutoxybis (acetylacetonate) are more preferable.

<Thiol Compounds (F)>

The radically polymerizable resin composition may contain one or more thiol compounds (F) selected from a secondary thiol compound (F-1) and a tertiary thiol compound (F-2). In the present invention, it is supposed that the thiol compound (F) has a function as a curing accelerator and also has a function of coordinating to the vicinity of the metal of the metal-containing compound (E) and preventing the deactivation of the metal by water.

The thiol compound (F) used in the present invention is not particularly limited as long as the compound has at least one mercapto group bonded to a secondary or tertiary carbon atom in the molecule (hereinafter, each of them may be referred to as a “secondary mercapto group” or a “tertiary mercapto group”), but from the viewpoint of rapidly advancing curing even in water and preventing the metal of the metal-containing compound (E) from being deactivated by water, a polyfunctional thiol which is a compound having at least two secondary or tertiary mercapto groups in the molecule is preferable, and among them, a bifunctional thiol which is a compound having two secondary or tertiary mercapto groups in the molecule is preferable. The secondary thiol compound (F-1) is more preferable to the tertiary thiol compound (F-2).

Here, “polyfunctional thiol” means a thiol compound having two or more mercapto groups as functional groups, and “bifunctional thiol” means a thiol compound having two mercapto groups as functional groups.

There is no particular restriction on the compound having two or more secondary or tertiary mercapto groups in the molecule, but, for example, a compound having at least one structure represented by formula (Q) and having two or more secondary or tertiary mercapto groups in the molecule is preferable, wherein the mercapto groups in the structure represented by formula (Q) is included among the two or more secondary or tertiary mercapto groups.

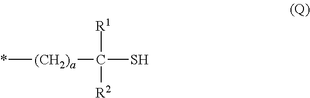

(In the formula (Q), R¹ is a hydrogen atom, an alkyl group having 1 to 10 carbon atoms, or an aromatic group having 6 to 18 carbon atoms; R² is an alkyl group having 1 to 10 carbon atoms or an aromatic group having 6 to 18 carbon atoms; * is linked to any organic group; and “a” is an integer of 0 to 2.)

[Secondary Thiol Compound (F-1)]

When the thiol compound (F) having a structure represented by formula (Q) is a secondary thiol compound (F-1), specific examples thereof include 3-mercaptobutyric acid, di (1-mercaptoethyl) 3-mercaptophthalate, di (2-mercaptopropyl) phthalate, di (3-mercaptobutyl) phthalate, ethylene glycol bis (3-mercaptobutyrate), propylene glycol bis (3-mercaptobutyrate), diethylene glycol bis (3-mercaptobutyrate), butanediol bis (3-mercaptobutyrate), octanediol bis (3-mercaptobutyrate), trimethylolethantris (3-mercaptobutyrate), tri methylolpropantris (3-mercaptobutylate), pentaerythritol tetrakis (3-mercaptobutylate), dipentaerythritol hexakis (3-mercaptobutylate), ethylene glycol bis (2-mercaptopropionate), propylene glycol bis (2-mercaptopropionate), diethylene glycol bis (2-mercaptopropionate), butanediol bis (2-mercaptopropionate), octanediol bis (2-mercaptopropionate), trimethylolpropantris (2-mercaptopropionate), pentaerythritol tetrakis (2-mercaptopropionate), dipentaerythritol hexakis (2-mercaptopropionate), ethylene glycol bis (4-mercaptovalate), diethylene glycol bis (4-mercapto valerate), butanediol bis (4-mercapto valerate), octanediol bis (4-mercapto valerate), trimethylolpropantris (4-mercapto valerate), pentaerythritol tetrakis (4-mercapto valerate), dipentaerythritol hexakis (4-mercapto valerate), ethylene glycol bis (3-mercapto valerate), propylene glycol bis (3-mercapto valerate), diethylene glycol bis (3-mercapto valerate), butanediol bis (3-mercapto valerate), octanediol bis (3-mercapto valerate), trimethylolpropantris (3-mercapto valerate), pentaerythritol tetrakis (3-mercaptovalerate), dipentaerythritol hexakis (3-mercaptovalerate), hydrogenated bisphenol A bis (3-mercaptobutylate), bisphenol A dihydroxyethyl ether-3-mercaptobutylate, 4,4′-(9-fluorenylidene) bis (2-phenoxyethyl (3-mercaptobutylate)), ethylene glycol bis (3-mercapto-3-phenylpropionate), propylene glycol bis (3-mercapto-3-phenylpropionate), diethylene glycol bis (3-mercapto-3-phenylpropionate), butanediol bis (3-mercapto-3-phenylpropionate), octanediol bis (3-mercapto-3-phenylpropionate), trimethylolpropantris (3-mercapto-3-phenylpropionate), tris-2-(3-mercapto-3-phenylpropionate) ethyl isocyanurate, pentaerythritol tetrakis (3-mercapto-3-phenylpropionate), di pentaerythritol hexakis (3-mercapto-3-phenylpropionate), and the like.

Among the secondary thiol compounds (F-1), commercially available compounds having two or more secondary mercapto groups in the molecule include 1, 4-bis (3-mercaptobutyryloxy) butane (KarenzMT (registered trademark) BD1, manufactured by Showa Denko K.K.), pentaerythritol tetrakis (3-mercaptobutyrate) (KarenzMT (registered trademark) PEI, manufactured by Showa Denko K.K.), 1, 3, 5-tris [2-(3-mercaptobutyryloxyethyl)]-1, 3, 5-triazine-2, 4, 6 (1H, 3H, 5H)-trione (KarenzMT (registered trademark) NR1, manufactured by Showa Denko K.K.), trimethylolethantris (3-mercaptobutyrate) (made by Showa Denko K.K., TEMB), trimethylolpropantris (3-mercaptobutyrate) (TPMB manufactured by Showa Denko K.K.) and the like, and it is preferable to use one or more of these compounds. Among them, 1, 4-bis (3-mercaptobutyryloxy) butane (KarenzMT (registered trademark) BD1, manufactured by Showa Denko K.K.) is preferable.

[Tertiary Thiol Compound (F-2)]

When the thiol compound (F) having a structure represented by formula (Q) is a tertiary thiol compound (F-2), specific examples thereof include di (2-mercaptoisobutyl) phthalate, ethylene glycol bis (2-mercaptoisobutyrate), propylene glycol bis (2-mercaptoisobutyrate), diethylene glycol bis (2-mercaptoisobutyrate), butanediol bis (2-mercaptoisobutyrate), octanediol bis (2-mercaptoisobutyrate), trimethylolethantris (2-mercaptoisobutyrate), trimethylolpropantris (2-mercaptoisobutyrate), pentaerythritol tetrakis (2-mercaptoisobutyrate), dipentaerythritol hexakis (2-mercaptoisobutyrate), di (3-mercapto-3-methylbutyl) phthalate, ethylene glycol bis (3-mercapto-3-methylbutyrate), propylene glycol bis (3-mercapto-3-methylbutyrate), diethylene glycol bis (3-mercapto-3-methylbutyrate), butanediol bis (3-mercapto-3-methylbutyrate), octanediol bis (3-mercapto-3-methylbutyrate), trimethylolethantris (3-mercapto-3-methylbutyrate), trimethylolpropantris (3-mercapto-3-methylbutyrate), pentaerythritol tetrakis (3-mercapto-3-methylbutyrate), and dipentaerythritol hexakis (3-mercapto methylbutyrate).

The total amount of the thiol compounds (F) in the radically polymerizable resin composition of the present invention is preferably 0.01 to 10 parts by mass, more preferably 0.1 to 7 parts by mass, still more preferably 0.1 to 5 parts by mass, and most preferably 0.2 to 4 parts by mass with respect to 100 parts by mass of the radically polymerizable compound (A). When the amount of the thiol compound (F) is 0.01 parts by mass or more, the curing function can be sufficiently obtained, and when the amount of the thiol compound (F) is 10 parts by mass or less, the curing proceeds rapidly.

Further, the total molar ratio of the thiol compound (F) to the metal component of the metal-containing compound (E) [(F)/(E)] is preferably 0.1 to 15; in one aspect of the invention, more preferably 0.3 to 10, still more preferably 0.6 to 8, most preferably 0.8 to 5, and particularly more preferably 0.5 to 15; in another aspect of the invention, more preferably 1 to 12, still more preferably 1.5 to 10, and most preferably 2 to 9. When the molar ratio [(F)/(E)] is 0.1 or more, the thiol compound (F) can be sufficiently coordinated to the vicinity of the metal of the metal-containing compound (E), and when the molar ratio is 15 or less, the balance between the production cost and the effect is improved.

One kind of the thiol compound (F) may be used alone, or two or more kinds may be used together. When the secondary thiol compound (F-1) and the tertiary thiol compound (F-2) are used together, the molar ratio of the secondary thiol compound (F-1) and the tertiary thiol compound (F-2) [(F-1)/(F-2)] is preferably 0.001 to 1000, and more preferably 1 to 10. When the molar ratio [(F-1)/(F-2)] is within the above range, the metal-containing compound (A) and the thiol compound (F) are stabilized in the radically polymerizable resin composition, and the disulfide compound due to the bonding between the thiol compounds (F) is not generated as a by-product. From the viewpoint of preserving the radical polymerizable resin composition in a stable state of the metal-containing compound (E) and the thiol compound (F), it is preferable to use a secondary thiol compound (F-1) or a tertiary thiol compound (F-2) alone.

<Curing Accelerator (G)>

The radically polymerizable resin composition may contain a curing accelerator (G) other than a metal-containing compound (E) and a thiol compound (F) for the purpose of improving curability.

Examples of the curing accelerator (G) other than the metal-containing compound (E) and the thiol compound (F) include amines. Specific examples of the amines include aniline; N, N-substituted aniline such as N, N-dimethylaniline, N, N-diethylaniline, p-toluidine, N, N-dimethyl-p-toluidine, N, N-bis (2-hydroxyethyl)-p-toluidine, 4-(N, N-dimethylamino) benzaldehyde, 4-[N, N-bis (2-hydroxyethyl) amino] benzaldehyde, 4-(N-methyl-N-hydroxyethylamino) benzaldehyde, N, N-bis (2-hydroxypropyl)-p-toluidine, N-ethyl-m-toluidine, triethanolamine, m-toluidine, diethylenetriamine, pyridine, phenylimorpholine, piperidine, N, N-bis (hydroxyethyl) aniline, diethanolaniline, and the like; N, N-substituted p-toluidine; 4-(N, N-substituted amino) benzaldehyde; and the like.

When the radically polymerizable resin composition of the present invention contains a curing accelerator (G), the amount thereof is preferably 0.01 to 10 parts by mass, more preferably 0.05 to 5 parts by mass, and still more preferably 0.1 to 3 parts by mass with respect to 100 parts by mass of the radically polymerizable compound (A).

<Fiber (H)>

The radically polymerizable composition of the present invention may optionally contain fibers. Specific examples of fibers used in the present invention include glass fibers, carbon fibers, vinylon fibers, nylon fibers, aramid fibers, polyolefin fibers, acrylic fibers, polyester fibers such as polyethylene terephthalate fibers, cellulose fibers and metal fibers such as steel fibers, and ceramic fibers such as alumina fibers. Among them, for example, polyolefin fibers can be used as the thixotropic agent. The thixotropic agent is blended for the purpose of imparting thixotropic properties.

The polyolefin fibers which are currently commercially available include polyethylene-based products such as Kemibesto (registered trademark) FDSS-2 (average fiber length 0.6 mm), Kemibesto (registered trademark) FDSS-5 (average fiber length 0.1 mm), Kemibesto (registered trademark) FDSS-25 (average fiber length 0.6 mm, hydrophilized product), and Kemibesto (registered trademark) FDSS-50 (average fiber length 0.1 mm, hydrophilized product), all of which are manufactured by Mitsui Petrochemical Industries, Ltd.

The carbon fiber is not particularly limited, and any of the known carbon fibers can be used. Examples of the carbon fiber include polyacrylonitrile-based (PAN-based) carbon fibers, rayon-based carbon fibers, pitch-based carbon fibers, and the like. The carbon fibers may be used individually or in a mixture of two or more. In view of low cost and good mechanical properties, it is preferable to use PAN-based carbon fibers. Such carbon fibers are available commercially. As the carbon fiber, carbon fiber reinforced plastic (CFRP) may be used.

The diameter of the carbon fiber is preferably 3 to 15 μm, and more preferably 5 to 10 μm. The length of the carbon fiber is usually 5 to 100 mm. In the present invention, carbon fibers may be cut to 10.0 mm to 100.0 mm, and may be further cut to 12.5 mm to 50.0 mm.

These fibers are preferably used in the form of a fiber structure, a biaxial mesh, a triaxial mesh, or the like, wherein the fiber structure is selected from, for example, plain weave, satin weave, nonwoven fabric, mat, roving, chop, knitting, braid, and composite structures thereof. For example, the fiber structure can be used by impregnating the fiber structure with a radically polymerizable composition, and in some cases prepolymerizing the fiber structure to prepreg the fiber structure.

For example, as the mesh, a biaxial mesh or a triaxial mesh may be used. Both of the length (mesh size) of one side of the square of the biaxial mesh and the length (mesh size) of one side of the equilateral triangle of the triaxial mesh are preferably 5 mm or more and more preferably 10 to 20 mm By using a biaxial mesh or a triaxial mesh, it is possible to obtain a curable material for preventing concrete flaking which is lightweight and excellent in economical efficiency, workability, and durability.

These fibers are preferably used for reinforcing coating film performance such as concrete flaking prevention property and FRP waterproof property, or for manufacturing FRP molded products.

In applications such as concrete flaking prevention, among the fibers, glass fibers, cellulose fibers, and the like having excellent transparency are preferable from the viewpoint that the deterioration state of the base material can be visually inspected from the outside.

The amount of such fibers is preferably 0.3 to 200 parts by mass, more preferably 0.5 to 100 parts by mass, and still more preferably 1.0 to 50 parts by mass with respect to 100 parts by mass of the radically polymerizable compound (A).

<Polymerization Inhibitor (I)>

The radically polymerizable resin composition may contain a polymerization inhibitor from the viewpoint of suppressing excessive polymerization of the radically polymerizable compound (A) and controlling the reaction rate.

Examples of the polymerization inhibitor include known ones such as hydroquinone, methyl hydroquinone, phenothiazine, catechol, and 4-tert-butyl catechol.

When the radically polymerizable resin composition contains a polymerization inhibitor (1), the amount thereof is 0.0001 to 10 parts by mass, and more preferably 0.001 to 1 parts by mass with respect to 100 parts by mass of the radically polymerizable compound (A).

<Curing Retarder (J)>

The radically polymerizable resin composition may contain a curing retarder for the purpose of delaying curing of the radically polymerizable compound (A). Examples of the curing retarder include free radical curing retarders, such as TEMPO derivatives such as 2, 2, 6, 6-tetramethylpiperidine-1-oxyl free radical (TEMPO), 4-hydroxy-2, 2, 6, 6-tetramethylpiperidine-1-oxyl free radical (4H-TEMPO), and 4-oxo-2, 2, 6, 6-tetramethylpiperidine-1-oxyl free radical (4-Oxo-TEMPO). Among these, 4-hydroxy-2, 2, 6, 6-tetramethylpiperidine-1-oxyl free radical (4H-TEMPO) is preferable from the viewpoint of cost and ease of handling.

When the radically polymerizable resin composition contains a curing retarder (J), the amount thereof is preferably 0.0001 to 10 parts by mass, and more preferably 0.001 to 1 parts by mass with respect to 100 parts by mass of the radically polymerizable compound (A).

<Water Reducing Agent (L)>

The radically polymerizable resin composition may optionally contain a usable water reducing agent (L) capable of imparting water reducing properties. As the water reducing agent, a known water reducing agent used for concrete such as a liquid or powder water reducing agent, an AE water reducing agent, a high-performance water reducing agent, and a high-performance AE water reducing agent can be used without limitation.

The polycarboxylic acid-based water reducing agent can suppress the deterioration of the fluidity of the concrete due to the addition of the aluminosilicate having the swellability described above, and is also suitable from the viewpoint of improving the workability by maintaining good fluidity.

As the water reducing agent, a known water reducing agent used for concrete such as a liquid or powdery water reducing agent, an AE water reducing agent, a high-performance water reducing agent, and a high-performance AE water reducing agent can be used without limitation.

The polycarboxylic acid-based water reducing agent can suppress the deterioration of the fluidity of the concrete due to the addition of the aluminosilicate having the swellability described above, and is also suitable from the viewpoint of improving the workability by maintaining good fluidity.

The water reducing agent is preferably contained in 0.1 to 3.0% by mass of the radically polymerizable resin composition.

<Other Components>

The radically polymerizable resin composition of the present invention may contain components other than the above components, as long as the components do not particularly hinder the strength development and acid resistance of the cured product. Examples of the components that can be contained include hydraulic inorganic materials such as calcium sulfate and pozzolan materials; admixtures that can be used for mortar or concrete that can impart properties such as setting adjustment, hardening acceleration, hardening delay, thickening, water retention, defoaming, water repellency, and waterproofing; and admixtures that can be used for mortar or concrete such as fibers made of materials such as metals, polymers, and carbon; pigments; extenders; foams; and clay minerals such as zeolites; and the like. In addition, examples of the components that can be contained include coupling agents, plasticizers, anion immobilizing components, solvents, polyisocyanate compounds, surfactants, wet dispersants, waxes, thixotropic agents, and the like.

[Coupling Agent]

In the radically polymerizable resin composition of the present invention, a coupling agent may be used for improving processability and for improving adhesion to a base material. Examples of the coupling agent include known silane-based coupling agents, titanate-based coupling agents, aluminum-based coupling agents, and the like.

Examples of such coupling agents include silane coupling agents represented by R³—Si (OR⁴)₃. Examples of R³ include aminopropyl group, glycidyloxy group, methacryloxy group, N-phenylaminopropyl group, mercapto group, vinyl group, and the like; and examples of R⁴ include methyl group, ethyl group, and the like.

When the radically polymerizable resin composition contains a coupling agent, the amount thereof is preferably 0.001 to 10 parts by mass with respect to 100 parts by mass of the radically polymerizable compound (A).

[Plasticizer]

The radically polymerizable resin composition of the present invention can optionally contain a plasticizer. Although the plasticizer is not particularly limited, for the purpose of adjusting physical properties and characteristics, examples of plasticizers include phthalate esters such as dibutyl phthalate, diheptyl phthalate, di (2-ethylhexyl) phthalate, and butyl benzyl phthalate; non-aromatic dibasic acid esters such as dioctyl adipate, dioctyl sebacate, dibutyl sebacate, and isodecyl succinate; aliphatic esters such as butyl oleate and methyl acetylricilinoleate; esters of polyalkylene glycols such as diethylene glycol dibenzoate, triethylene glycol dibenzoate, and pentaerythritol esters; phosphoric esters such as tricresyl phosphate and tributyl phosphate; trimellitic ester; polystyrenes such as polystyrene and poly-α-methylstyrene; polybutadiene, polybutene, polyisobutylene, butadiene-acrylonitrile, and polychloroprene; chlorinated paraffins; hydrocarbon-based oils such as alkyldiphenyls and partially hydrogenated terphenyls; process oil; polyethers such as derivatives obtained by converting hydroxyl groups of polyether polyols into ester groups, ether groups, and the like, wherein examples of the polyether polyols include polyethylene glycol, polypropylene glycol, and polytetramethylene glycol; epoxy plasticizers such as epoxidized soybean oil and benzyl epoxystearate; polyester plasticizers obtained from dibasic acids such as sebacic acid, adipic acid, azelaic acid, and phthalic acid and dihydric alcohols such as ethylene glycol, diethylene glycol, triethylene glycol, propylene glycol, and dipropylene glycol; and vinyl polymers obtained by polymerizing vinyl monomers such as acrylic plasticizers by various methods.

Particularly, since the viscosity of the radically polymerizable composition and mechanical properties such as tensile strength and elongation of the cured product obtained by curing the composition can be adjusted, it is preferable to add a polymer plasticizer which is a polymer having a number-average molecular weight of 500 to 15000. The polymer plasticizer is preferable because it can maintain initial physical properties for a long period of time as compared with the case of using a small molecule plasticizer which is a plasticizer not containing a polymer component in the molecule. The polymer plasticizer may or may not have a functional group.

The number-average molecular weight of the polymer plasticizer is more preferably 800 to 10000, and still more preferably 1000 to 8000. When the number-average molecular weight is 500 or more, the continuous exuding of the plasticizer due to the influence of heat, rainfall, and water is suppressed, and the initial physical properties can be maintained for a long period. Further, if the number-average molecular weight is 15000 or less, the viscosity increase can be suppressed, and sufficient workability can be secured.

[Anion Immobilization Compound]

Hydrotalcites or hydrocalmites may be used to immobilize anions such as chloride ions.

The hydrotalcite may be a natural product or a synthetic product, and can be used regardless of the presence or absence of surface treatment or crystal water. Examples of the hydrotalcite include basic carbonates represented by the following general formula (R).

Mₓ.Mg_{y}.Al_{Z}CO₃(OH)_{xr+2y+3z-2}.mH₂O (R)

(In the formula, M is an alkali metal or zinc, x is a number of 0 to 6, y is a number of 0 to 6, z is a number of 0.1 to 4, r is the valence of M, and m is the number of crystal water of 0 to 100.)

The hydrocalumite may be a natural product or a synthetic product, and can be used regardless of the presence or absence of surface treatment or crystal water. For example, the products represented by the following general formulae (S) and (T) can be used:

3CaO.Al₂O₃.CaX₂.kH₂O (S)

(X is a monovalent anion, k≤20.)

3CaO.Al₂O₃.CaY.kH₂O (T)

(Y is a divalent anion, k≤20.)

In addition, nitrite ion (NO₂⁻), which is believed to be effective in suppressing corrosion of reinforcing bars, is supported by the calmites at the manufacturing stage, and examples of anions that can be supported include nitrate ion (NO₃⁻), hydroxide ion (OH⁻), oxalate ion (CH₃COO⁻), carbonate ion (CO₃⁻), sulfate ion (SO₄²⁻), and the like.

These hydrotalcites or hydrocalumites may be used alone, but may be used by mixing them into cement paste.

When mixed with cement paste, hydroxide ion (OH⁻) coexisting in hydration reaction or sulfate ion (SO₄²⁻) contained in cement is assumed to have various effects on anion exchange reaction which is a characteristic of carmite. In view of maintaining the exchange reaction with the desired chloride ion, hydrocalumites supporting nitrite ion are preferable.

[Solvent]

The radically polymerizable resin composition of the present invention may optionally be blended with a solvent. Examples of solvents that can be blended include aromatic hydrocarbon solvents such as toluene and xylene; ester solvents such as ethyl acetate, butyl acetate, amyl acetate, and cellosolve acetate; and ketone-based solvents such as methyl ethyl ketone, methyl isobutyl ketone, and diisobutyl ketone. These solvents may be used in the manufacture of polymers.

[Polyisocyanate Compound]

The radically polymerizable resin composition may contain a polyisocyanate compound. The polyisocyanate compound reacts with the hydroxyl group of the radical polymerizable compound (A) to form a cured coating film.

The polyisocyanate compound contains two or more isocyanate groups in the molecule, and the isocyanate groups may be blocked by a blocking agent or the like.

Examples of the polyisocyanate compound not blocked by the blocking agent include aliphatic diisocyanates such as lysine diisocyanate, hexamethylene diisocyanate, trimethylhexane diisocyanate, and the like; cyclic aliphatic diisocyanates such as hydrogenated xylylene diisocyanate, isophorone diisocyanate, methylcyclohexane-2, 4 (or 2, 6)-diisocyanate, 4, 4′-methylenebis (cyclohexyl isocyanate), and 1, 3-(isocyanatomethyl) cyclohexane; aromatic diisocyanates such as tolylene diisocyanate, xylylene diisocyanate, and diphenylmethane diisocyanate; and trivalent or higher polyisocyanates such as lysine triisocyanates. Examples of the polyisocyanate compound not blocked by the blocking agent also include adducts of these polyisocyanates with polyhydric alcohols, low molecular weight polyester resins, water, or the like; cyclized polymers of the diisocyanates (for example, isocyanurate); biuret type adducts; and the like. Among them, isocyanurate of hexamethylene diisocyanate is preferable.

These polyisocyanate compounds may be used alone or in combination of two or more.

When the radically polymerizable resin composition contains a polyisocyanate compound, the amount thereof is preferably 0.1 to 50 parts by mass, more preferably 1 to 30 parts by mass, and still more preferably 2 to 20 parts by mass with respect to 100 parts by mass of the radically polymerizable compound (A).

The blocked polyisocyanate compound is obtained by blocking an isocyanate group of the polyisocyanate compound with a blocking agent.

Examples of blocking agents include a phenolic compound such as phenol, cresol, xylenol, or the like; epsilon-caprolactam; lactams such as δ-valerolactam, γ-butyrolactam, and β-propiolactam; alcoholic systems such as methanol, ethanol, n-propyl or isopropyl alcohol, n-, iso- or tert-butyl alcohol, ethylene glycol monomethyl ether, ethylene glycol monoethyl ether, ethylene glycol monobutyl ether, diethylene glycol monomethyl ether, diethylene glycol monoethyl ether, propylene glycol monomethyl ether, and benzyl alcohol; oximes such as formamidoxime, acetaldoxime, acetoxime, methylethylketoxime, diacetylmonoxime, benzophenone oxime, and cyclohexane oxime; and active methylene such as dimethyl malonate, diethyl malonate, ethyl acetoacetate, methyl acetoacetate, and acetylacetone. The isocyanate group of the polyisocyanate can be easily blocked by mixing the polyisocyanate with the blocking agent.

When the polyisocyanate compound is an unblocked polyisocyanate compound, the radical polymerizable compound (A) in the radical polymerizable resin composition of the present invention and the polyisocyanate compound are mixed to cause reactions between the two compounds, so that it is preferable to separate the radical polymerizable compound (A) and the polyisocyanate compound before use and to mix them when use.

A curing catalyst can be used for reacting the radical polymerizable compound (A) with the polyisocyanate compound. Examples of suitable curing catalysts include organometallic catalysts such as tin octylate, dibutyltin di (2-ethylhexanoate), dioctyltin di (2-ethylhexanoate), dioctyltin diacetate, dibutyltin dilaurate, dibutyltin oxide, dioctyltin oxide, and lead 2-ethylhexanoate.

When the radically polymerizable resin composition contains the curing catalyst, the amount thereof is preferably 0.01 to 5 parts by mass, and more preferably 0.05 to 4 parts by mass with respect to 100 parts by mass of the radically polymerizable compound (A).

[Surfactant]

The radically polymerizable resin composition may contain a surfactant.

Examples of surfactants include anionic surfactants, nonionic surfactants, cationic surfactants, and amphoteric surfactants. These surfactants may be used alone or in combination of two or more surfactants.

Among these surfactants, one or more surfactants selected from anionic surfactants and nonionic surfactants are preferable.

Examples of the anionic surfactant include an alkyl sulfate ester salt such as sodium lauryl sulfate and triethanolamine lauryl sulfate; a polyoxyethylene alkyl ether sulfate ester salt such as sodium polyoxyethylene lauryl ether sulfate and polyoxyethylene alkyl ether sulfate triethanolamine; sulfonate such as dodecylbenzene sulfonic acid, sodium dodecylbenzene sulfonate, sodium alkylnaphthalene sulfonate, and sodium dialkylsulfosuccinate; fatty acid salts such as sodium stearate soap, potassium oleate soap, and potassium castor oil soap; naphthalenesulfonic acid formalin condensates; special polymer systems; and the like.

Among these, sulfonate is preferable, sodium dialkylsulfosuccinate is more preferable, and sodium dioctylsulfosuccinate is still more preferable.

Examples of nonionic surfactants include polyoxyethylene derivatives such as polyoxyethylene alkyl ethers such as polyoxylauryl ether, polyoxyethylene cetyl ether, polyoxyethylene stearyl ether, polyoxyethylene oleyl ether, polyoxyethylene distyrenated phenyl ether, polyoxyethylene tribenzyl phenyl ether, polyoxyethylene polyoxypropylene glycol, and the like; sorbitan fatty acid esters such as polyoxyalkylene alkyl ethers, sorbitan monolaurylate, sorbitan monopalmitate, and sorbitan monostearate; polyoxyethylene sorbitan fatty acid esters such as polyoxyethylene sorbitan monolaurate, polyoxyethylene sorbitan monolaurate, and polyoxyethylene sorbitan monopalmitate; polyoxyethylene sorbitol fatty acid esters such as polyoxyethylene sorbitol tetraoleate; and glycerol fatty acid esters such as glycerol monostearate and glycerol monooleate.

Among these, polyoxyethylene lauryl ether, polyoxyethylene cetyl ether, polyoxyethylene stearyl ether, polyoxyethylene oleyl ether, and polyoxyethylene alkyl ether are preferable. The nonionic surfactant HLB (hydrophile-lipophil balance) is preferably 5 to 15, and more preferably 6 to 12.

When the radically polymerizable resin composition contains a surfactant, the amount thereof is preferably 0.01 to 10 parts by mass, more preferably 0.05 to 7 parts by mass, and still more preferably 0.1 to 5 parts by mass with respect to 100 parts by mass of the radically polymerizable compound (A).

[Wet Dispersant]

The radically polymerizable resin composition of the present invention may contain, for example, a wet dispersant to improve permeability to wet or submerged portions to be repaired.

Examples of the wet dispersant include a fluorine-based wet dispersant and a silicone-based wet dispersant, which may be used alone or in combination of two or more kinds.

Examples of commercially available fluorine-based wet dispersants include Megafack (registered trademark) F 176, Megafack (registered trademark) R 08 (manufactured by Dainippon Ink and Chemicals, Inc.), PF 656, PF 6320 (manufactured by OMNOVA Inc.), Troisol S-366 (manufactured by Troy Chemical Co., Ltd.), Florard FC 430 (manufactured by 3M Japan Co., Ltd.), polysiloxane polymer KP-341 (manufactured by Shin-Etsu Chemical Co., Ltd.), and the like.

Examples of commercial silicone-based wet dispersants include BYK (registered trademark)-322, BYK (registered trademark)-377, BYK (registered trademark)-UV 3570, BYK (registered trademark)-330, BYK (registered trademark)-302, BYK (registered trademark)-UV 3500, BYK-306 (manufactured by BYK-Chemie Japan Co., Ltd.), polysiloxane polymer KP-341 (manufactured by Shin-Etsu Chemical Co., Ltd.), and the like.

The silicone-based wet dispersant preferably contains a compound represented by formula ail

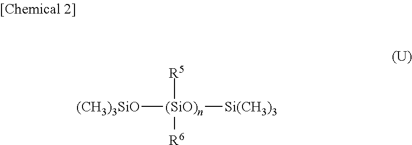

(In the formula, R⁵ and R⁶ each independently represent a hydrocarbon group which may contain an aromatic ring having 1 to 12 carbon atoms, or —(CH₂)₃O(C₂H₄O)ₚ(CH₂CH(CH₃)O)_{q}R′, wherein n is an integer of 1 to 200, R′ is an alkyl group having 1 to 12 carbon atoms, p and q are integers, respectively, and q/p=0 to 10 is satisfied.)

Examples of the silicone-based wet dispersant containing the compound represented by formula (U) include BYK (registered trademark)-302 and BYK (registered trademark)-322 (manufactured by BYK-Chemie Japan Co., Ltd.).

When the radically polymerizable resin composition of the present invention contains a wet dispersant, the amount thereof is preferably 0.001 to 5 parts by mass, and more preferably 0.01 to 2 parts by mass with respect to 100 parts by mass of the radically polymerizable compound (A).

[Wax]

The radically polymerizable resin composition may contain wax.

Examples of the wax include paraffin waxes and polar waxes, which may be used alone or in combination of two or more kinds.

As the paraffin waxes, known ones having various melting points can be used. Examples of the polar wax include NPS (registered trademark)-8070, NPS (registered trademark)-9125 (made by Nippon Seiro Co., Ltd.), Emanone (registered trademark) 3199, Emanone (registered trademark) 3299 (made by Kao Corporation), and the like.

When the radically polymerizable resin composition of the present invention contains wax, the amount thereof is preferably 0.05 to 4 parts by mass, and more preferably 0.1 to 2.0 parts by mass with respect to 100 parts by mass of the radically polymerizable compound (A). However, when the radically polymerizable resin composition of the present invention is used in water, it is preferable not to use the wax because there is a risk of the wax being eluted into water.

[Thixotropic Agent]

In the radically polymerizable resin composition of the present invention, a thixotropic agent may be used for viscosity adjustment or the like for securing workability on a vertical surface or a ceiling surface.

Examples of the thixotropic agent include inorganic thixotropic agents and organic thixotropic agents, and examples of organic thixotropic agents include hydrogenated castor oil-based thixotropic agent, amide-based thixotropic agent, polyethylene oxide-based thixotropic agent, vegetable oil-polymerized oil-based thixotropic agent, surfactant-based thixotropic agent, and composite-based thixotropic agent in which these are used in combination. Specific examples of the thixotropic agent include DISPARLON (registered trademark) 6900-20 X (Kusumoto Kasei K. K.).

Examples of the inorganic thixotropic agents include silica-based thixotropic agent and bentonite-based thixotropic agent; examples of the hydrophobic thixotropic agents include REOLOSIL (registered trademark) PM-20 L (a vapor phase silica manufactured by Tokuyama Corporation Co., Ltd.) and Aerosil (registered trademark) AEROSIL R-106 (Japan Aerosil Co., Ltd.); and examples of the hydrophilic ones include Aerosil (registered trademark) AEROSIL-200 (Japan Aerosil Co., Ltd.). From the viewpoint of further improving the thixotropic property, a material obtained by adding a thixotropic modifier such as BYK (registered trademark)-R 605 or BYK (registered trademark)-R 606 (manufactured by BYK-Chemie Japan Co., Ltd.) to a hydrophilic fired silica can also be suitably used. When the radically polymerizable resin composition of the present invention contains a thixotropic agent, the amount thereof is preferably 0.01 to 10 parts by mass, and more preferably 0.1 to 5 parts by mass with respect to 100 parts by mass of the radically polymerizable compound (A).

<Water>

The radically polymerizable resin composition of the present invention substantially contains no water from the viewpoint of obtaining a practical level of strength. That is, when the radically polymerizable resin composition is prepared, water is not added as a component of the composition. For example, the water amount of the radically polymerizable resin composition is preferably less than 0.25 parts by mass, more preferably not more than 0.20 parts by mass, still more preferably not more than 0.15 parts by mass, and most preferably not more than 0.10 parts by mass with respect to 100 parts by mass of the radically polymerizable compound (A).

<Method for Producing Radically Polymerizable Resin Composition>

The method for producing the radically polymerizable resin composition of the present invention is not particularly limited, and a method known in the art can be used. For example, the radically polymerizable resin composition can be produced by mixing the radically polymerizable compound (A) with the metal-containing compound (E) as necessary, and further mixing the radically polymerizable compound (A) with a radical polymerization initiator (C), an aggregate (D) containing cement, and an expansive additive (B).

One embodiment of a method for producing a radically polymerizable resin composition of the present invention comprises a step (S1) of mixing a radically polymerizable compound (A) with a metal-containing compound (E) as necessary to obtain a resin product, a step (S2) of mixing a radical polymerization initiator (C) with the obtained resin product to obtain a curable resin product, and a step (S3) of mixing the obtained curable resin product with an aggregate (D) containing cement and an expansive additive (B) to obtain a radically polymerizable resin composition.

In the step (S1) of obtaining the resin product (sometimes simply referred to as the “Step (S1)”), a polymerization inhibitor (I), a curing retarder (J), a thiol compound (F), or the like may be mixed as necessary in addition to mixing the metal-containing compound (E) with the radically polymerizable compound (A).

In the step (S3) (sometimes referred to simply as “Step (S3)”) of obtaining the radically polymerizable resin composition, the curable resin product obtained in the step (S2) (sometimes referred to simply as “Step (S2)”) of obtaining the curable resin product may be mixed with a water reducing agent (L), a fiber (H), or the like, as necessary, in addition to mixing an aggregate (D) containing cement and an expansive additive (B). Specific examples of the aggregate (D) include, for example, early-strength Portland cement, calcium carbonate TM-2, perlite FL-0, HARDLITE B-04, Enshu 5.5 silica sand, N 50 silica sand, N 40 silica sand, N 90 silica sand, and the like.

The radically polymerizable resin composition thus produced can be cured at room temperature and is excellent in workability, early strength development, and curability. Since the radically polymerizable resin composition contains the expansive additive (B), the shrinkage rate at the time of curing is small, and the expansion rate of the cured product can be made larger than 0 in some conditions.

<Cured Product of Radically Polymerizable Resin Composition>

The cured product of the radically polymerizable resin composition is obtained by curing the radically polymerizable resin composition.

[Method for Curing Radically Polymerizable Resin Composition]

When the radically polymerizable resin composition of the present invention contains a thermal radical polymerization initiator (C1), one example of a curing method of the radically polymerizable resin composition of the present invention includes a curing method in which the radically polymerizable resin composition of the present invention is applied to the surface of a base material and cured at room temperature. For example, the radically polymerizable resin composition of the present invention is used as a cross section repairing material of a structure composed of inorganic substances. Since the radically polymerizable resin composition of the present invention contains an expansive additive (B), the cured product thus obtained does not largely shrink as in the prior art even after a certain time elapses.

Examples of the base material include concrete, asphalt concrete, mortar, brick, wood, and metal; thermosetting resins such as phenol resin, epoxy resin, melamine resin, urea resin, unsaturated polyester resin, vinyl ester resin, alkyd resin, polyurethane, and polyimide; and thermoplastic resins such as polyethylene, polypropylene, polyvinyl chloride, polystyrene, polyvinyl acetate, polyurethane, Teflon (registered trademark), ABS resin, AS resin, acrylic resin, and the like.

When the radically polymerizable resin composition of the present invention contains a photo-radical polymerization initiator (C2), as the photo-curing timing, a method in which the radically polymerizable resin composition is applied to a base material and then photo-cured, or a method in which the radically polymerizable resin composition is pre-polymerized (also referred to as B-staged or pre-pregulated) to form a sheet, and the sheet is stuck to the base material and then photo-cured, may be used.

As the light source, any light source having a spectral distribution in the photosensitive wavelength region of the photo-radical polymerization initiator (C2) may be used, for example, a solar light, an ultraviolet lamp, a near-infrared lamp, a sodium lamp, a halogen lamp, a fluorescent lamp, a metal halide lamp, an LED, and the like may be used. It is also possible to use different wavelengths necessary for prepolymerization and polymerization by using two or more kinds of photoradical polymerization initiators (C2) in combination, to use a wavelength-cut filter as a light source, or to use a specific wavelength of an LED. The wavelength used for the prepolymerization is desirably a long wavelength having a low energy level, and the degree of polymerization can be easily controlled, especially when near-infrared light is used. In the present invention, ultraviolet light (ultraviolet ray) refers to a light beam having a wavelength of 280 to 380 nm, visible light (visible ray) refers to a light beam having a wavelength of 380 to 780 nm, and near infrared light (near infrared ray) refers to a light beam having a wavelength of 780 to 1200 nm. The irradiation time of the lamp required for the prepolymerization cannot be generally defined because the effective wavelength range of the light source, the output, the irradiation distance, the thickness of the composition, and the like may affect the irradiation time; however, the irradiation time may be, for example, 0.01 hours or more, and preferably 0.05 hours or more.

### EXAMPLES

Although the present invention will be described in more detail with reference to the following examples, the present invention is not limited in any way by the examples.

<Method for Measuring Curing Shrinkage>

The shrinkage/expansion rate (rate of change: negative is shrinkage, positive is expansion) after curing of a cured product of the radically polymerizable resin composition of the present invention was measured in accordance with Japanese Standard JIS A 1129-3 (dial gauge method). The molding (cured product) was made by referring to Annex A of Japanese Standard JIS A 1129. Formwork for the test piece of 40×40×160 mm defined in Japanese standard JIS R 5201 was used. The test piece of the cured product was molded according to the method of making the test piece for strength test prescribed in 10 of JIS R 5201, and after molding, the test piece was left as a mold and was left standing (cured) in a room at a temperature of 23° C.±2° C. and at a humidity of 50%, and was removed from the mold about 24 hours after molding. Then, the measurement was started under the conditions indicated in 4.3 of JIS A 1129-3 using the instrument indicated in 3 of JIS A 1129-3 (time is set to 0).

Amount of change(Negative:Shrinkage,Positive:Expansion)=Length of long side at elapsed time−Length(160 mm) of long side at start(time is set to 0) (1)

Rate of change(Negative:Shrinkage,Positive:Expansion)=Amount of change/Length(160 mm) of long side at start(time is set to 0) (2)

The raw materials used for producing each of the radically polymerizable resin compositions in the examples and comparative examples are shown as follows.

<Radical Polymerizable Compound (A)>

Radical-Polymerizable Compound (A-1)

Unsaturated polyester resin RIGOLAC (registered trademark), Showa Denko K.K., SR-110 N (styrene content 40% by mass)

### Synthesis Example 1

[Synthesis of Radically Polymerizable Compounds (A-2)]

In a 4-neck separable flask of 1 L capacity equipped with a stirrer, a reflux condenser, a gas introduction tube, and a thermometer, 150.4 g of AER-2603 (bisphenol A type epoxy resin manufactured by Asahi Kasei: epoxy equivalent 189), 188.4 g of SR-16 H (1, 6-hexanediol diglycidyl ether manufactured by Sakamoto Pharmaceutical Industries, Ltd.), and 0.255 g of methyl hydroquinone and 1.5 g of DMP-30 (2, 4, 6-tris (dimethylaminomethyl) phenol manufactured by Tokyo Kasei Kogyo Co., Ltd.) were added, and then it was heated to 110° C. After the temperature was raised to 110° C., 172 g of methacrylic acid (manufactured by Mitsubishi Rayon Co., Ltd.) was added dropwise over about 30 minutes, and reaction was carried out for about 4 hours. When the acid value became 10 mg KOH/g, the reaction was completed to obtain a vinyl ester compound.

Then, 256.3 g of dicyclopentenyloxyethyl methacrylate (FA-512 MT manufactured by Hitachi Chemical Co., Ltd.) and 85.4 g of dicyclopentanyl methacrylate (FA-513 M manufactured by Hitachi Chemical Co., Ltd.) were added as the radically polymerizable unsaturated monomer to obtain a non-styrene radical polymerizable compound (A-2) having a viscosity at 25° C. of 280 mPa s and an ester compound component ratio of 60% by mass.

<Expansive Additive (B)>

B-1: Taiheiyo Hyper Expansive additive K (for structural use) made by Taiheiyo Materials Corporation as a quicklime-based expansive additive

B-2: Taiheiyo N-EX made by Taiheiyo Materials Corporation as quicklime expansive additive (early-strength expansive additive)

B-3: Denka CSA #10 as an ettringite-based expansive additive

B-4: Denka Power CSA Type S as quicklime/etringite composite-based expansive additive

<Radical Polymerization Initiator (C)>

As the thermal radical polymerization initiator, (C-1) cumene hydroperoxide (CHP), PERCUMYL (registered trademark) H-80 manufactured by Nichiyu Co., Ltd., was used.

As the thermal radical polymerization initiator, (C-2) diisopropylbenzene hydroperoxide, PERCUMYL (registered trademark) P manufactured by Nichiyu Co., Ltd., was used.

As the thermal radical polymerization initiator, (C-3) benzoyl peroxide, and Niper (registered trademark) NS manufactured by Nichiyu Co., Ltd. were used.

As the thermal radical polymerization initiator, (C-4) methyl ethyl ketone peroxide, produced by Nichiyu Oil Co., Ltd., and Permec (registered trademark) N were used.

<Aggregate (D)>

Aggregate (D-1):
Early-strength Portland Cement
Calcium Carbonate TM-2
Perlite FL-0
HARDLITE B-04
Enshu 5.5 Silica Sand
N 50 Silica Sand
N 40 Silica Sand

Aggregate (D-II):
Bond P Mortar Aggregate, manufactured by Konishi (including early-strength Portland cement)

<Metal-Containing Compound (E)>

Cobalt (E-1) octylate (HEXOATE COBALT, manufactured by Toei Kako Co., Ltd., containing 8% by mass of cobalt and having a molecular weight of 345.34) was used as a metallic soap.

Manganese (E-2) octylate (HEXOATE,MANGANESE, manufactured by Toei Kako Co., Ltd., containing 8% by mass manganese in the entire product, molecular weight 341.35) was used as a metallic soap.

<Thiol Compound (F)>

As the secondary thiol compound (F-1), a bifunctional secondary thiol, Karenz MT (registered trademark) BD1 (1, 4-bis (3-mercaptobutyryloxy) butane, molecular weight 299.43, manufactured by Showa Denko K.K.), was used.

<Curing Accelerator (G)>

As the curing accelerator (G-1), dimethylaniline (DMA manufactured by Tokyo Kasei Industry Co., Ltd.) was used.

<Fiber (H)>

Kemibesto (registered trademark) FDSS-5

Multibranched polyolefin fibers manufactured by Mitsui Chemicals Fine Co., Ltd.

<Polymerization Inhibitor (I)>

Tertiary butyl catechol was used as the polymerization inhibitor (I-1).

Dibutylhydroxytoluene was used as the polymerization inhibitor (I-2).

<Curing Retarder (J)>

4-H-TEMPO was used.

<Epoxy Resin>

Main Agent: Epoxy Resin, Bond E 208 W, manufactured by Konishi Corporation Curing agent: Curing agent for epoxy resin, Bond E 208 W, manufactured by

Konishi Co., Ltd.

### Example 1

“Preparation of Radically Polymerizable Resin Compositions”

(1) Step (S1):

A resin product was prepared by mixing a metal-containing compound (E), a thiol compound (F), a polymerization inhibitor (I), and a curing retarder (J) with the radically polymerizable compound (A-2) obtained in Synthesis Example 1 at the blending amount shown in Table 1.

(2) Step (S2):

The curable resin product was prepared by mixing the resin product obtained in Step (S1) with the radical polymerization initiator (C) at the blending amount shown in Table 1.

(3) Step (S3):

The radically polymerizable resin composition of the present embodiment was obtained by mixing the curable resin product obtained in Step (S2) with the expansive additive (B), the aggregate (D), and the fiber (H) in the components and the blending amounts shown in Table 1.

The mixing conditions for each step are as follows.

Stirrer: HOMOGENIZING DISPER Model 2.5 (made by Primus)

Stirring speed: 3000 to 5000 rpm

Temperature: 25° C.

“Preparation of Cured Product of Radically Polymerizable Resin Compositions”

The radically polymerizable resin composition thus obtained was injected into a 40×40×160 mm mold, and the mold was cured by standing (curing) in a room at a temperature of 23° C.±2° C. and at a humidity of 50%, and was removed from the mold about 24 hours after molding. A cured product of the radically polymerizable resin composition of the present example was obtained.

“Evaluation of Shrinkage and Expansion Properties of Cured Products”

The cured product of the radically polymerizable resin composition was evaluated by the above evaluation method. The results are shown in FIG. 1.

“Evaluation of Fluidity of Resin Composition”

The fluidity of the resin composition was evaluated using Ultra Point Gun sold by Pccox Japan Sales Co., Ltd.

An object to be evaluated was the radically polymerizable resin composition after mixing in Step (S3).

A 200 g radical polymerizable resin composition is filled in the Ultra Point Gun, and a lot rod is set according to a prescribed operation. Thereafter, the trigger is pulled, and whether or not the radically polymerizable resin composition came out from the tip of the nozzle is used as an index.

When the radically polymerizable resin composition came out, it was evaluated as “O”, and when the radically polymerizable resin composition did not come out, it was evaluated as “X”. When the radically polymerizable resin composition mixed in Step (S3) is separated and only the resin came out, it was evaluated as “A” t. The results are shown in Table 1.

### Examples 2 to 13 and 15 to 20, Comparative Examples 1 to 6 and 10 to 15

Each radically polymerizable resin composition was obtained in the same manner as in Example 1, except that each component and the amount of mixture shown in Table 1 were used. Each cured product of the radically polymerizable resin composition was prepared by the same method as in Example 1. Then, the shrinkage and expansion properties of each cured product were evaluated in the same manner as in Example 1. The results are shown in FIGS. 1 to 2, 6 to 9, 10, and 11.

### Reference Example 1

In Step (S3), a radically polymerizable resin composition was obtained in the same manner as in Example 1, except that 10 parts by mass of water was mixed into the curable resin product obtained in Step (S2), with respect to 100 parts by mass of the resin product. A cured product of the radically polymerizable resin composition was prepared by the same method as in Example 1. The shrinkage and expansion properties of the cured product were evaluated in the same manner as in Example 1. The results are shown in FIG. 5.

### Comparative Example 7 and Comparative Example 8

Instead of the radically polymerizable composition of Example 1, the aggregate (D-II) and epoxy resin shown in Table 2 were used to obtain the epoxy resin composition. A cured product of the epoxy resin composition was prepared by the following method. Then, the shrinkage and expansion properties of the respective cured products were evaluated in the same manner as in Example 1. The results are shown in FIG. 3.

### Example 14 and Comparative Example 9

A radically polymerizable resin composition was obtained in the same manner as in Example 1, except that each component and the amount of mixture shown in Table 2 were used. A cured product of the radically polymerizable resin composition was prepared by the same method as in Example 1. Then, the shrinkage and expansion properties of the respective cured products were evaluated in the same manner as in Example 1. The results are shown in FIG. 4.

“Preparation of Cured Epoxy Resin Compositions”

After the main agent of the epoxy resin and the curing agent were mixed well, the aggregate (D-11) and the early-strength Portland cement were mixed, and the mixture was injected into a 40×40×160 mm mold, and the mold was cured by standing (curing) in a room having a temperature of 23° C.±2° C. and a humidity of 50%, and the mold was removed about 24 hours after molding. A cured product of the epoxy resin composition of this comparative example was obtained.

TABLE 1

| | | | Example | | | | | | | | | | |
|---|---|---|---|---|---|---|---|---|---|---|---|---|---|
| Table 1-1 Unit (g) | | | 1 | 2 | 3 | 4 | 5 | 6 | 7 | 8 | 9 | 10 | 11 |
| Resin | Radically polymerizable | A-1 | | | | | | | | 99.88 | | | |
| product | compound (A) | A-2 | 98.35 | 98.035 | 98.35 | 98.35 | 98.35 | 98.95 | 99.40 | | 98.35 | 98.35 | 98.35 |
| | Metal-containing | E-1 | | | | | | | | 0.07 | | | |
| | compound (E) | E-2 | 1.00 | 1.00 | 1.00 | 1.00 | 1.00 | 1.00 | | | 1.00 | 1.00 | 1.00 |
| | Thiol compound (F) | F-1 | 0.50 | 0.50 | 0.50 | 0.50 | 0.50 | | | | 0.50 | 0.50 | 0.50 |
| | Curing accelerator (G) | G-1 | | | | | | | 0.5 | | | | |
| | Polymerization inhibitor | I-1 | 0.05 | 0.05 | 0.05 | 0.05 | 0.05 | | 0.1 | | 0.05 | 0.05 | 0.05 |
| | (I) | I-2 | | | | | | 0.05 | | 0.05 | | | |
| | Curing retarder (J) | J-1 | 0.10 | 0.10 | 0.10 | 0.10 | 0.10 | | | | 0.10 | 0.10 | 0.10 |

| Water | | | | | | | | | | | | |
|---|---|---|---|---|---|---|---|---|---|---|---|---|
| Expansive additive (B) | B-1 | | 12.00 | | | | | | | | | |
| | B-2 | | | 12.00 | | | | | | | | |
| | B-3 | | | | 12.00 | | | | | | | |
| | B-4 | 12.00 | | | | 12.00 | 12.00 | 12.00 | 12.00 | 4.00 | 8.00 | 20.00 |
| Radical polymerization initiator (C) | C-1 | 2.00 | 2.00 | 2.00 | 2.00 | | 2.00 | | | 2.00 | 2.00 | 2.00 |
| | C-2 | | | | | 4.00 | | | | | | |
| | C-3 | | | | | | | 3.00 | | | | |
| | C-4 | | | | | | | | 1.50 | | | |
| Aggregate (D-I) | d-1 | 60.0 | 60.0 | 60.0 | 60.0 | 60.0 | 60.0 | 60.0 | 60.0 | 62.0 | 61.0 | 58.1 |
| | d-2 | 35.0 | 35.0 | 35.0 | 35.0 | 35.0 | 35.0 | 35.0 | 35.0 | 35.5 | 35.2 | 34.0 |
| | d-3 | 35.0 | 35.0 | 35.0 | 35.0 | 35.0 | 35.0 | 35.0 | 35.0 | 35.5 | 35.2 | 34.0 |
| | d-4 | 6.0 | 6.0 | 6.0 | 6.0 | 6.0 | 6.0 | 6.0 | 6.0 | 6.2 | 6.1 | 5.9 |
| | d-5 | 35.0 | 35.0 | 35.0 | 35.0 | 35.0 | 35.0 | 35.0 | 35.0 | 35.5 | 35.2 | 34.0 |
| | d-6 | | | | | | | | | | | |
| | d-7 | 180.0 | 180.0 | 180.0 | 180.0 | 180.0 | 180.0 | 180.0 | 180.0 | 183.8 | 182.1 | 178.0 |
| | d-8 | 35.0 | 35.0 | 35.0 | 35.0 | 35.0 | 35.0 | 35.0 | 35.0 | 35.5 | 35.2 | 34.0 |

| | | | | | | | | | | | |
|---|---|---|---|---|---|---|---|---|---|---|---|
| Total amount of Aggregate (D-I) | 386.0 | 386.0 | 386.0 | 386.0 | 386.0 | 386.0 | 386.0 | 386.0 | 394.0 | 390.0 | 378.0 |

| | | | | | | | | | | | | |
|---|---|---|---|---|---|---|---|---|---|---|---|---|
| Fiber (H) | H-l | 2.00 | 2.00 | 2.00 | 2.00 | 2.00 | 2.00 | 2.00 | 2.00 | 2.00 | 2.00 | 2.00 |

| | | | | | | | | | | | |
|---|---|---|---|---|---|---|---|---|---|---|---|
| Fluidity evaluation using ultra point gun | ◯ | ◯ | ◯ | ◯ | ◯ | ◯ | ◯ | ◯ | ◯ | ◯ | ◯ |

| | | | Example | | Comparative Example | | | | | | Reference Example |
|---|---|---|---|---|---|---|---|---|---|---|---|
| Table 1-2 Unit (g) | | | 12 | 13 | 1 | 2 | 3 | 4 | 5 | 6 | 1 |
| Resin | Radically polymerizable | A-1 | | | | | | | 99.88 | | |
| product | compound (A) | A-2 | 98.35 | 98.35 | 98.35 | 98.35 | 98.95 | 99.40 | | 98.35 | 98.35 |
| | Metal-containing | E-1 | | | | | | | 0.07 | | |
| | compound (E) | E-2 | 1.00 | 1.00 | 1.00 | 1.00 | 1.00 | | | 1.00 | 1.00 |
| | Thiol compound (F) | F-1 | 0.50 | 0.5 | 0.50 | 0.50 | | | | 0.50 | 0.50 |
| | Curing accelerator (G) | G-1 | | | | | | 0.5 | | | |
| | Polymerization inhibitor | I-1 | 0.05 | 0.05 | 0.05 | 0.05 | | 0.1 | | 0.05 | 0.05 |
| | (I) | I-2 | | | | | 0.05 | | 0.05 | | |
| | Curing retarder (J) | J-1 | 0.10 | 0.1 | 0.10 | 0.10 | | | | 0.10 | 0.10 |

| Water | | | | | | | | | | 10.00 |
|---|---|---|---|---|---|---|---|---|---|---|
| Expansive additive (B) | B-1 | | | | | | | | | |
| | B-2 | | | | | | | | | |
| | B-3 | | | | | | | | | |
| | B-4 | 30.00 | 40.00 | | | | | | | 12.00 |
| Radical polymerization initiator (C) | C-1 | 2.00 | 2.00 | 2.00 | | 2.00 | | | 2.00 | 2.00 |
| | C-2 | | | | 4.00 | | | | | |
| | C-3 | | | | | | 3.00 | | | |
| | C-4 | | | | | | | 1.50 | | |
| Aggregate (D-I) | d-1 | 57.5 | 55.0 | 62.0 | 62.0 | 62.0 | 62.0 | 62.0 | | 60.0 |
| | d-2 | 32.5 | 31.4 | 36.0 | 36.0 | 36.0 | 36.0 | 36.0 | 36.0 | 35.0 |
| | d-3 | 32.5 | 31.4 | 36.0 | 36.0 | 36.0 | 36.0 | 36.0 | 36.0 | 35.0 |
| | d-4 | 5.5 | 5.4 | 6.5 | 6.5 | 6.5 | 6.5 | 6.5 | 6.5 | 6.0 |
| | d-5 | 32.5 | 31.4 | 36.0 | 36.0 | 36.0 | 36.0 | 36.0 | 36.0 | 35.0 |
| | d-6 | | | | | | | | 62.0 | |
| | d-7 | 175.0 | 172.0 | 185.5 | 185.5 | 185.5 | 185.5 | 185.5 | 185.5 | 180.0 |
| | d-8 | 32.5 | 31.4 | 36.0 | 36.0 | 36.0 | 36.0 | 36.0 | 36.0 | 35.0 |

| | | | | | | | | | |
|---|---|---|---|---|---|---|---|---|---|
| Total amount of Aggregate (D-I) | 368.0 | 358.0 | 398.0 | 398.0 | 398.0 | 398.0 | 398.0 | 398.0 | 386.0 |

| | | | | | | | | | | |
|---|---|---|---|---|---|---|---|---|---|---|
| Fiber (H) | H-l | 2.00 | 2.00 | 2.00 | 2.00 | 2.00 | 2.00 | 2.00 | 2.00 | 2.00 |

| | | | | | | | | | |
|---|---|---|---|---|---|---|---|---|---|
| Fluidity evaluation using ultra point gun | ◯ | X | ◯ | ◯ | ◯ | ◯ | ◯ | X | ◯ |

The meanings of the symbols for each component in Table 1 are shown as follows.

A-1 Rigolac (registered trademark) SR-110 N

E-1 Cobalt octylate

I-1 Tert-butyl catechol

1-2 Dibutylhydroxytoluene

J-1 4H-TEMPO

G-1 Dimethyl aniline

C-1 PERCUMYL (registered trademark) H-80

C-2 PERCUMYL (registered trademark) P

C-3 Niper (registered trademark) NS

C-4 Permec (registered trademark) N

B-1 Taiheiyo Hyper Expansive additive K (structural)

B-2 Taiheiyo N-EX (Early strength expansive additive)

B-3 Denka CSA #10

B-4 Denka Power CSA Type S

d-1 Early-Strength Portland Cement

d-2 Calcium carbonate TM-2

d-3 Perlite FL-0

d-4 HARDLITE B-04

d-5 Enshu 5.5 Silica sand

d-6 N 90 Silica sand

d-7 N 50 Silica sand

d-8 N 40 Silica sand

d-9 N 70 Silica sand

TABLE 2

| | | | Comparative | Comparative | Comparative | |
|---|---|---|---|---|---|---|
| Unit (g) | | | Example 7 | Example 8 | Example 9 | Example 14 |
| Resin product | Radically polymerizable | A-2 | | | 98.35 | 98.35 |
| | compound (A) | | | | | |
| | Metal-containing | E-2 | | | 1.00 | 1.00 |
| | compound (E) | | | | | |
| | Thiol compound (F) | F-1 | | | 0.50 | 0.50 |
| | Polymerization inhibitor | 4-tert-butylcatechol | | | 0.05 | 0.05 |
| | (I) | | | | | |
| | Curing retarder (J) | 4-H-TEMPO | | | 0.10 | 0.10 |
| Epoxy resin | Main agent | Bond E208W | 90.00 | 90.00 | | |
| | Curing agent | Bond E208W | 45.00 | 45.00 | | |

| | | | | | |
|---|---|---|---|---|---|
| Expansive additive (B) | B-4 Denka Power | None | 12.00 | None | 12.00 |
| | CSA Type S | | | | |
| Radical polymerization initiator (C) | C-1 PERCUMYL ® | | | 2.00 | 2.00 |
| | H-80 | | | | |
| Aggregate (D-II) | Bond P mortar | 345.0 | 333.0 | 340.0 | 328.0 |
| | aggregate | | | | |
| | Early-strength | 60.0 | 60.0 | 60.0 | 60.0 |
| | Portland cement | | | | |

| | | | | |
|---|---|---|---|---|
| Total amount of Aggregate (D-II) | 405.0 | 393.0 | 400.0 | 388.0 |

| | | |
|---|---|---|
| Fluidity evaluation using ultra point gun | X | X |

TABLE 3

| | | | | | Comparative Example | | | | | | Example | | | | | |
|---|---|---|---|---|---|---|---|---|---|---|---|---|---|---|---|---|
| Table 3 Unit (g) | | | | Example 1 | 10 | 11 | 12 | 13 | 14 | 15 | 15 | 16 | 17 | 18 | 19 | 20 |
| Resin product | Radically polymerizable | A-1 | SR-1 ION | | | | | | | | | | | | | |
| | compound (A) | A-2 | CR-2000-1 | 98.35 | 98.35 | 98.35 | 98.35 | 98.35 | 98.35 | 98.35 | 98.35 | 98.35 | 98.35 | 98.35 | 98.35 | 98.35 |
| | Metal-containing | E-1 | Cobalt octylate | | | | | | | | | | | | | |
| | compound (E) | E-2 | Manganese octylate | 1.00 | 1.00 | 1.00 | 1.00 | 1.00 | 1.00 | 1.00 | 1.00 | 1.00 | 1.00 | 1.00 | 1.00 | 1.00 |
| | Thiol compound (F) | F-1 | BD-1 | 0.50 | 0.50 | 0.50 | 0.50 | 0.50 | 0.50 | 0.50 | 0.50 | 0.50 | 0.50 | 0.50 | 0.50 | 0.50 |
| | Curing accelerator (G) | G-1 | Dimethyl aniline | | | | | | | | | | | | | |
| | Polymerization | I-1 | TBC | 0.05 | 0.05 | 0.05 | 0.05 | 0.05 | 0.05 | 0.05 | 0.05 | 0.05 | 0.05 | 0.05 | 0.05 | 0.05 |
| | inhibitor (I) | I-2 | BHT | | | | | | | | | | | | | |
| | Curing retarder (J) | J-1 | 4H-TEMPO | 0.10 | 0.10 | 0.10 | 0.10 | 0.10 | 0.10 | 0.10 | 0.10 | 0.10 | 0.10 | 0.10 | 0.10 | 0.10 |

| Water | | After-added free water | | | | | | | | | | | | | |
|---|---|---|---|---|---|---|---|---|---|---|---|---|---|---|---|
| Expansive additive (B) | B-4 | Power CSA S | 12.00 | 0.15 | 0.3 | 3.0 | 6.0 | 7.5 | 9 | 10.5 | 13.5 | 15 | 18 | 21 | 24 |
| Radical polymerization initiator (C) | C-1 | CHP | 2.00 | 2.00 | 2.00 | 2.00 | 2.00 | 2.00 | 2.00 | 2.00 | 2.00 | 2.00 | 2.00 | 2.00 | 2.00 |
| Aggregate (D-I) | d-1 | Early-strength cement | 60.0 | 0.4 | 0.4 | 10.0 | 20.0 | 40.0 | 48.0 | 52.0 | 65.0 | 67.5 | 80.0 | 100.0 | 121.0 |
| | d-2 | Calcium carbonate | 35.0 | | | 7.0 | 14.0 | 25.0 | 36.0 | 40.0 | 55.0 | 60.0 | 70.0 | 100.0 | 101.0 |
| | d-3 | Perlite FL-0 | 35.0 | | | 7.0 | 14.0 | 21.0 | 23.0 | 25.0 | 40.0 | 45.0 | 60.0 | | |
| | d-4 | Perlite B-04 | 6.0 | 0.15 | 0.2 | 15.0 | 30.0 | 4.0 | 4.0 | 4.5 | 9.5 | 10.0 | 15.0 | | |
| | d-5 | Enshu 5.5 Silica Sand | 35.0 | | | 7.0 | 14.0 | | | 16.0 | 30.0 | 40.0 | 55.0 | 129.0 | 101.0 |
| | d-6 | N90 | | 4.0 | 3.8 | 8.0 | 11.0 | 30.0 | 13.0 | | | | | | |
| | d-9 | N70 | | | | 42.5 | 90.0 | 120.0 | 165.0 | 140.0 | | | | | |
| | d-7 | N50 | 180.0 | | | | | | | 60.0 | 170.0 | 140.0 | 120.0 | | |
| | d-8 | N40 | 35.0 | | | | | | | | 65.0 | 120.0 | 180.0 | 349.0 | 452.5 |
| | Total amount of Aggregate (D-I) | | 386.0 | 4.55 | 4.40 | 96.5 | 193.0 | 240.0 | 289.0 | 337.5 | 434.5 | 482.5 | 580.0 | 678.0 | 775.5 |
| Fiber (H) | H-l | Kemibesto | 2.00 | 0.3 | 0.3 | 0.5 | 1.0 | 2.5 | 2.0 | 2.0 | 2.0 | 2.5 | 2.0 | 1.0 | 0.5 |

| | | | | | | | | | | | | | |
|---|---|---|---|---|---|---|---|---|---|---|---|---|---|
| Fluidity evaluation using ultra point gun | ◯ | ◯ | ◯ | ◯ | ◯ | ◯ | ◯ | ◯ | ◯ | ◯ | ◯ | Δ | Δ |

FIG. 1 is a graph showing the results of Examples 1 to 4 and Comparative Example 1. Volumetric shrinkage of the cured product was observed in the radically polymerizable resin composition of Comparative Example 1 which did not contain the expansive additive (B). On the other hand, the volume expansion of the cured product in the radically polymerizable resin composition of Examples 1 to 3 containing the expansive additive (B) was observed. In the radically polymerizable resin composition of Example 4, volumetric shrinkage was observed within about 0.5 hours from the start of curing, and thereafter, volumetric expansion was observed.

FIG. 2 is a graph showing the results of Example 5 and Comparative Example 2. For comparison, Example 1 and Comparative Example 1 shown in FIG. 1 are also shown. From the results of FIG. 2, it was found that the addition effect of the expansive additive (B) of the present invention does not depend on the type of radical polymerization initiator.

FIG. 3 is a graph showing the results of Comparative Example 7 and Comparative Example 8. The epoxy resin compositions of Comparative Example 7 and Comparative Example 8 do not contain a radical polymerization initiator (C). In Comparative Example 8 including the expansive additive (B), the volume expansion effect as in Example 1 was not observed. That is, in the system without the radical polymerization initiator (C), no expansion effect was observed even when the expansive additive (B) was included.

FIG. 4 is a graph showing the results of Example 9 and Comparative Example 14. Even when the aggregate (D-II) different from the aggregate (D-I) was used, a volume expansion effect similar to that in Example 1 was observed in Example 9.

FIG. 5 is a graph showing the results of Example 1 and Reference Example 1. A test was carried out in a state where with respect to 100 parts by mass of the resin product, 10 parts by mass of water was intentionally mixed. When water was mixed, the initial expansion effect is much larger than the case when water was not mixed. Reference Example 1 is a test example in which water is added without regard to practicability in order to show the effect of Example 1. The cured product obtained in Reference Example 1 is expected to have a greatly reduced strength, and as a result, to obtain unbalanced performance (water resistance, salt resistance, etc.).

FIG. 6 is a graph showing the results of Example 6 and Comparative Example 3. Example 6 and Comparative Example 3 do not contain a thiol compound (F) or a curing retarder (J-1). In Example 6 including the expansive additive, the expansion effect was confirmed, and in Comparative Example 3 not including the expansive additive, the expansion effect was not observed. Therefore, it was found that the thiol compound (F) and the curing retarder (J-1) did not react with the expansive additive.

FIG. 7 is a graph showing the results of Example 7 and Comparative Example 4. The compositions in Example 7 and Comparative Example 4 do not contain a metal-containing compound (E) and a thiol compound (F). The compositions further contain a curing accelerator (G), and the types of polymerization inhibitors (I) are different. The expansion effect was confirmed in Example 7 including the expansive additive, and the expansion effect was not confirmed in Comparative Example 4 not including the expansive additive. Therefore, it was found that the metal-containing compound (E) did not react with the expansive additive, and that it did not depend on the type of the polymerization inhibitor (I) and on the presence or absence of the curing accelerator (G).

FIG. 8 is a graph showing the results of Example 8 and Comparative Example 5. In Example 8 and Comparative Example 5, the radical polymerizable compound (A) is different from others, and the type of the metal-containing compound (E) is different. The radical polymerization initiator (C) is also different from the others. Example 8 including the expansive additive has a clear expansion effect compared with Comparative Example 5 not including the expansive additive. Therefore, it was found that whether or not the expansion effect was expressed did not depend on the type of radical polymerizable compound (A) and on the type of metal-containing compound (E).

FIG. 9 is a graph showing the results of Examples 9 to 13. In Examples 9 to 13, the added amount of each expansive additive is increased or decreased as compared with Example 1. Although the expansion effect is different according to the amount of the expansive additive, it was found that the expansion effect is greater when the amount of the expansive additive is larger.

FIG. 10 is a graph showing the results of Examples 1, 15, and Comparative Examples 10 to 15. FIG. 11 is a graph showing the results of Examples 1 and 16 to 20. In Examples 15 to 20 and Comparative Examples 10 to 15, the total amount of aggregate (D) was increased or decreased as compared with Example 1. In Examples 15 to 20, the same volume expansion effect as in Example 1 was observed, but in Comparative Examples 10 to 15, no volume expansion effect was observed.

The results of the fluidity evaluation with the ultra point gun described at the bottom of Tables 1 and 2 are shown. In Example 13 and Comparative Examples 6, 7, and 8, the radically polymerizable resin composition did not come out even when the nozzle of the ultra point gun was pulled. Further, in Example 14 and Comparative Example 9, when the nozzle of the ultra point gun is pulled, only the radical polymerizable compound (A) is extruded and comes out.

In Example 13, the amount of expansive additive added is extremely large, and it is considered that the fluidity of the radically polymerizable resin composition was extremely deteriorated. In Comparative Example 6, the early-strength Portland cement was removed from Example 1 and replaced with the early-strength Portland cement of aggregate (D-I). As a result, it is considered that the fluidity of the composition without early-strength Portland cement deteriorated.

Further, in Comparative Examples 7 and 8, the main agent of the epoxy resin and the curing agent of the epoxy resin, and the aggregate (D-II) are mixed, but it is considered that the fluidity of the obtained mixture as the epoxy resin composition is too poor.

Although Comparative Examples 9 and 14 use aggregates (D-II), similar to Comparative Examples 7 and 8, there is almost no fluidity regardless of the presence or absence of an expansive additive. It is considered that, unlike the main agent of the epoxy resin and the curing agent of the epoxy resin, since the radically polymerizable compound (A) is defeated by the nozzle pressure of the ultra point gun, only the radically polymerizable compound (A) is exuded.

The expansion/shrink rate (rate of change: negative is shrinkage, positive is expansion) of the present invention was measured under the conditions indicated in 4.3 of JIS A 1129-3 with a time of 0, after the molding was performed by standing (curing) in a room at a temperature of 23° C.±2° C. and at a humidity of 50%, and the mold was removed in about 24 hours. That is, the conditions during the test period were 20±2° C. temperature and 60±5% relative humidity. Under such conditions, it was confirmed that the volume expansions of the radically polymerizable resin composition of Examples 1 to 4 were observed due to the inclusion of the expansive additive (B) without adding water in the reaction system. In particular, it was found that Examples 1 to 3 including an expansive additive having a quicklime component had a higher expansion rate than Example 4. The radical polymerization initiator (C) was also found to be an essential component.

As a result of the present invention, it is possible to prepare a composition in which the rate of change of the cured product is close to zero after a certain period of time, for example, by adjusting the optimum blending amount of a resin component, a cement component, a radical polymerization initiator, an expansive additive, and the like.

1. A radically polymerizable resin composition, comprising:
a radical polymerizable compound (A);
an expansive additive (B);
a radical polymerization initiator (C); and
an aggregate (D),
wherein the aggregate (D) comprises a cement, and
an amount of the aggregate (D) is 330 to 800 parts by mass with respect to 100 parts by mass of the radically polymerizable compound (A).

2. The radically polymerizable resin composition according to claim 1,
wherein the radically polymerizable compound (A) comprises a vinyl ester resin and a radically polymerizable unsaturated monomer.

3. The radically polymerizable resin composition according to claim 1, wherein the expansive additive (B) comprises at least one selected from the group consisting of quicklime and calcium sulfoaluminate.

4. The radically polymerizable resin composition according to claim 1, wherein the radical polymerization initiator (C) is a hydroperoxide.

5. The radically polymerizable resin composition according to claim 1, further comprising a metal-containing compound (E) and a thiol compound (F).

6. The radically polymerizable resin composition according to claim 1, wherein an amount of the expansive additive (B) is 0.3 to 30 parts by mass with respect to 100 parts by mass of the radically polymerizable compound (A).

7. The radically polymerizable resin composition according to claim 1, wherein an amount of the radical polymerization initiator (C) is 0.1 to 10 parts by mass with respect to 100 parts by mass of the radically polymerizable compound (A).

8. A cured product of the radically polymerizable resin composition according to claim 1.
